(19) United States
(12) Patent Application Publication
(10) Pub. No.: US 2009/0054092 A1
(43) Pub. Date: Feb. 26, 2009

(54) Interactive Interface for Devices Supporting Communication Employing Sender-Specified Media Content

(76) Inventors: Anthony Pierre Stonefield, Sherman Oaks, CA (US); Shane Richard Dewing, Sherman Oaks, CA (US)

Correspondence Address: GORDON & JACOBSON, P.C., 60 LONG RIDGE ROAD, SUITE 407, STAMFORD, CT, 06902, US

(21) Appl. No.: 12/195,096

(22) Filed: Aug. 20, 2008

Related U.S. Application Data
(60) Provisional application No. 60/956,812, filed on Aug. 20, 2007.
(60) Provisional application No. 60/981,175, filed on Oct. 19, 2007.

(51) Int. Cl. H04W 8/00; G06Q 30/00

(52) U.S. Cl. 455/466; 705/27

(57) ABSTRACT

A software application that is installed on a device as part of a system for establishing communication between a first user device and at least one second user device. The communication includes a first-user-specified media content item. For example, the first-user-specified media content item can be played or displayed on the second user device prior to (or concurrent with) the establishment of the communication (which can be a voice call, text message, media push communication, IM message, PTT call, etc.). Alternatively, the first-user-specified media content can be played on the second user device without soliciting or engaging in other communication. The software application includes a graphical user interface that enables the second party to review, interact with, purchase and forward (push) the media content item communicated thereto as well as other graphical user interfaces that are common to all communication parties and enables the parties (whichever they may be at any instant) to push, receive, review, interact with, purchase and forward the media content communicated thereto as well as to access information or actions associated with the media content relayed between the parties or referenced on the graphical user interface.

### CROSS-REFERENCE TO RELATED APPLICATIONS

This application claims priority from U.S. Provisional Application No. 60/956,812, filed on Aug. 20, 2007, and U.S. Provisional Application No. 60/981,175, filed on Oct. 19, 2007, and is related to PCT Patent Application No. PCT/US07/66914, filed on Apr. 19, 2007, and U.S. patent application Ser. No. 11/463,974 filed on Aug. 11, 2006 (which claims priority from U.S. Provisional Application No. 60/745,134 filed on Apr. 19, 2006); herein incorporated by reference in their entireties.

### BACKGROUND OF THE INVENTION

1. Field of the Invention

This invention relates broadly to communication systems. More particularly, this invention relates to communications systems for peer-to-peer real-time communication (such as voice, Instant Messaging and Push-to-Talk communication) and other communication systems.

2. State of the Art

In modern voice communication systems, when a call is made to a called party, a ring tone is played at the called party's telephony device in order to announce the incoming call to the called party. In the case of a traditional wire line telephone, the ring tone is played in response to a 90-volt 20-hertz AC wave generated by the central office switch that is connected to the called party's telephony device. In the case of a wireless communication system, the ring tone is typically generated on the called party's mobile handset in response to a call connection request communicated thereto from a switching center or the like. Mobile handsets typically also allow for a vibrating alert to announce incoming calls. The vibrating alert is especially useful in noisy environments, in places where ring tone noise would be disturbing, and for the hearing impaired.

Newer wireless mobile handsets allow the user to select the ring tone from a collection of ring tones, and also to select a ring tone for each user listed in the handset's phonebook. When the handset receives a call connection request from a user listed in the handset's phonebook, the ring tone associated with the user is played to announce the incoming call. Newer mobile handsets can also use short pieces of music as ring tones, and the sale of these ring tones has become a major sector of the mobile music industry.

Early mobile handsets had the ability to play only monophonic ring tones, which are short tunes played with simple tones. These early phones also had the ability to have ring tones programmed into them using an internal ring tone composer. Various formats were developed to enable ring tones to be sent via SMS text, for example RTTTL encoding.

Modern mobile handsets are now able to play more complex polyphonic ring tones. Polyphonic means that multiple notes can be played at the same time using instrument sounds such as guitar, drums, electronic piano, etc. Polyphonic ring tones are typically pieces of recorded music or other sounds contained in a conventional audio file (e.g., AAC, MP3, WMA, WAV, QCP, or AMR format) and played by suitable software applications that execute on the mobile handset. Polyphonic ring tones can also be based upon midi sequences. Many polyphonic capable handsets are able to play standard midi files, others play sp-midi files. The sp-midi file encodes a scalable polyphonic ring tone. The number of available channels that can be concurrently played on the handset dictates the notes played by the handset in rendering the sp-midi file. More particularly, an older polyphonic capable handset may play 4 notes at once, while a newer handset may be capable of rendering 128 notes at once.

Ring tones have proven a popular method of personalizing mobile handsets. In response to this demand, wireless carriers and other content providers have developed businesses that generate significant revenue resulting from the distribution of ring tones to mobile handset users. However, personalization of the ring tones played on mobile handset is controlled exclusively by the user of the handset. This limits the amount of personalization that can be achieved as part of the voice call process and thus limits potential revenues that could be derived by additional personalization of the voice call process.

U.S. Patent Publication No. 2006/0026277 to Sutcliffe describes a system and method for “pushing” a caller-defined multimedia announcement or alert within the call set-up process. It is possible for the called party to hear or see the caller-defined multimedia announcement before answering the incoming call. The caller-defined multimedia content is transferred during call set-up and replaces standard ring tones on the recipient's mobile handset. This process allows for additional personalization of the voice call process. However, U.S. Patent Publication No. 2006/0026277 fails to address many important issues that arise in this process, including but not limited to user control and management of the multimedia announcement communication process on a system wide basis and on a user by user basis, and access control over the multimedia content transferred to the recipient's mobile handset.

Instant Messaging (“IM”) communications systems were originally developed for personal computers, but have evolved to mobile phone networks. IM communication systems employ presence, selected contact list (“buddy list”), permissions, alerts and emoticons to support real-time peer-to-peer and group messaging between users. Push-to-talk (PTT) communication systems combine aspects of cellular mobile communications, presence, and walkie-talkie style peer-to-peer and group voice communications between users. Push-to-talk functionality provides users with the ability to quickly find one another and engage in brief, burst-oriented style communication. PTT functionality is provided in half-duplex mode (e.g. transmission occurs in both directions, but not at the same time). Thus, each party must wait to speak. The user experience for both mobile IM communication and PTT communication is uniform—a monophonic tone and message display alert the receiving/called party each time a sending/calling party transmits an IM message or PPT call, respectively.

Thus, there remains a need in the art for methods, systems and services based thereon for peer-to-peer real-time communication (such as voice, IM, and/or PPT communications) that allow for personalization of the communication process and that allows for potential revenue growth from such additional personalization of the communication process.

### SUMMARY OF THE INVENTION

The present invention provides a system and methodology for peer-to-peer communication (such as voice, texting, IM and Push-to-talk communication) and multi-party communication (such as voice conferencing, multi-party texting, multi-party IM conferencing, and multi-party Push-to-talk communication) that allows for personalization of the communication process.

The present invention also provides a system and methodology for peer-to-peer and multi-party communication that allows for potential revenue growth from such personalization, from content sharing, and from the effect of pass-along of auto/self-merchandizing media.

The present invention also provides a communication system and methodology that enriches the communication process with customizable and interactive multimedia content.

In accord with these objects, which will be discussed in detail below, a software application is installed on communication devices as part of a system for establishing communication between a first user device (e.g., a calling-party device for voice or PTT communication and a sending-party device for text, IM, or basic media push communications) and one or more second user devices (e.g., called-party device(s) for voice or PTT communication or receiving-party device(s) for text, IM, or basic media push communication). The communication is initiated by the first user via interaction with the first user device. The first user also specifies media content associated with the communications. The first-user-specified media content is communicated to and played or displayed on the second user device (for example, prior to or concurrent with the establishment of a communication session therebetween to announce the first-user-initiated communication). Alternatively, the first-user-specified media content can be played on the second user device without soliciting or engaging in other communication. The software application includes a graphical user interface that concurrently presents the following elements on the second user device in conjunction with the communication:
a first element that identifies the first user;
a second element that identifies the first-user-specified media content; and
a third element that enables the second user to initiate a transaction for the first-user-specified media content.
   In the preferred embodiment, the transaction can be a purchase transaction or a save transaction. Upon completion of the purchase transaction, the DRM license data associated with the media content is preferably updated to allow for expanded consumption of the media content. When purchased or saved, the media content can be stored locally on the second-user device or possibly on a remote system for subsequent access and use in communications that are initiated by the second party.

The graphical user interface can also concurrently present additional elements with respect to those listed above, such as element(s) that invoke certain actions (such as reply, forward, preview, stop, pause, volume control, etc.) associated with a given communication.

The graphical user interface can also concurrently present additional elements with respect to those listed above, such as an element that identifies the purchase price of the first-user-specified media content, an element that provides a link to information related to the first-user-specified media content, an element that enables the second user to accept or terminate the communication, and/or other additional features as described herein.

Additionally, the software application can include a graphical user interface that is common to all communication parties and enables the parties (whichever they may be at any instant) to push, receive, review and save or purchase the media content communicated thereto as well as to access information or actions associated with the media content relayed between the parties or referenced on the graphical user interface.

Additionally, the software application can include a graphical user interface that enables back-and-forth peer-to-peer communication of media content during an ongoing communication session or as the very communication itself, as might be the case with photo sharing or relaying of voice message recordings.

In another aspect, a system is provided for real-time communication between a first user operating a first user device and at least one second user operating a respective second user device. The first user device includes means for interacting with the first user to identify the at least one second user and to select media content for communication to the respective second user device as part of the real-time communication. The system includes a server and at least one relay node. The server includes or interfaces to at least one database for storing presence data and permissions data for a plurality of users (including the second user(s)). The server also includes means for communicating with the first user device to determine serviceability of the second user(s) for the real-time communication based upon the presence data and permissions data corresponding to the second user(s). The relay node(s) communicate the media content selected by the first user to the respective second user device as part of the real-time communication by relaying the media content as a plurality of chunks. The functionality of the relay node can be realized on a processing platform of the server or on a communication node separate from the server. The media content can be played or displayed on the respective second user device to announce the real-time communication. In the preferred embodiment, the real-time communication is selected from the group consisting of: voice communication, SMS text messaging, MMS messaging, IM messaging systems, Push-to-Talk communication, and a game challenge.

Additional objects and advantages of the invention will become apparent to those skilled in the art upon reference to the detailed description taken in conjunction with the provided figures.

### BRIEF DESCRIPTION OF THE DRAWINGS

FIG. 1 is a functional block diagram of a system for peer-to-peer voice communications that employs communication of a media-based call alert command from a calling-subscriber device to a called-subscriber device in accordance with the present invention.

FIG. 2 is a block diagram of exemplary functionality embodied by the network elements of FIG. 1 (or FIG. 9) in carrying out a voice call communication process in accordance with a first embodiment of the present invention.

FIG. 3 is a schematic diagram of an exemplary graphical user interface that is displayed on the terminal devices of FIG. 1 (or FIG. 9) for registering and subscribing to a communication service in accordance with the present invention.

FIG. 4 is a schematic diagram of an exemplary buddy list interface that is displayed on the terminal devices of FIG. 1 (or FIG. 9) for communicating presence information and permissions associated with subscribers of the communication service of the present invention, and for invoking voice calls to such subscribers.

FIG. 5 is a flow chart illustrating exemplary operations carried out by the RP Voice Call Setup block of the application executing on the called-subscriber terminal of FIG. 2 (or FIG. 6A) in accordance with the present invention.

FIG. 6A is a block diagram of exemplary functionality embodied by the network elements of FIG. 1 (or FIG. 9) in carrying out a voice call communication process in accordance with a second embodiment of the present invention.

FIGS. 6B-6D are flow charts illustrating operations embodied by certain functions of FIG. 6A.

FIG. 7 is pictorial illustration of an exemplary buddy list interface that is displayed on the terminal devices of FIG. 1 (or FIG. 9), which utilizes a set of multi-tiered icons to communicate device compatibility information, presence information and permissions and status information associated with subscribers of the communication service of the present invention.

FIG. 8A is a table illustrating an exemplary set of icons used in the buddy list interface of FIG. 7 to communicate device compatibility information associated with subscribers of the communication service of the present invention.

FIG. 8B is a table illustrating an exemplary set of icons used in the buddy list interface of FIG. 7 to communicate presence information associated with subscribers of the communication service of the present invention.

FIG. 8C is a table illustrating an exemplary set of icons used in the buddy list interface of FIG. 7 to communicate permissions and status information associated with subscribers of the communication service of the present invention.

FIG. 9 is a functional block diagram of an exemplary communication system that includes a variety of different access networks (mobile, fixed and wireless access networks) and that supports peer-to-peer voice call communications which employ communication of a media-based call alert command from a calling-subscriber device to a called-subscriber device in accordance with the present invention.

FIGS. 10A and 10B are functional block diagrams of subscriber terminal devices of FIG. 9 in accordance with the present invention.

FIGS. 11A through 11E are pictorial illustrations of exemplary graphical user interfaces that are invoked on a called-subscriber device in accordance with the present invention.

FIGS. 12A1 through 12B are pictorial illustrations of exemplary graphical user interfaces that are invoked on subscriber devices in accordance with the present invention.

FIGS. 13A1 to 13G2 are pictorial illustrations of exemplary graphical user interfaces that are invoked on subscriber devices in accordance with the present invention.

FIGS. 14A to 14D, collectively, is a flow chart that outlines exemplary communication processes for use with the graphical user interfaces of FIGS. 13A1 to 13G2 in accordance with the present invention.

### DETAILED DESCRIPTION OF THE PREFERRED EMBODIMENTS

The term “Peer-to-Peer” as used herein refers to communication between two users via corresponding user devices.

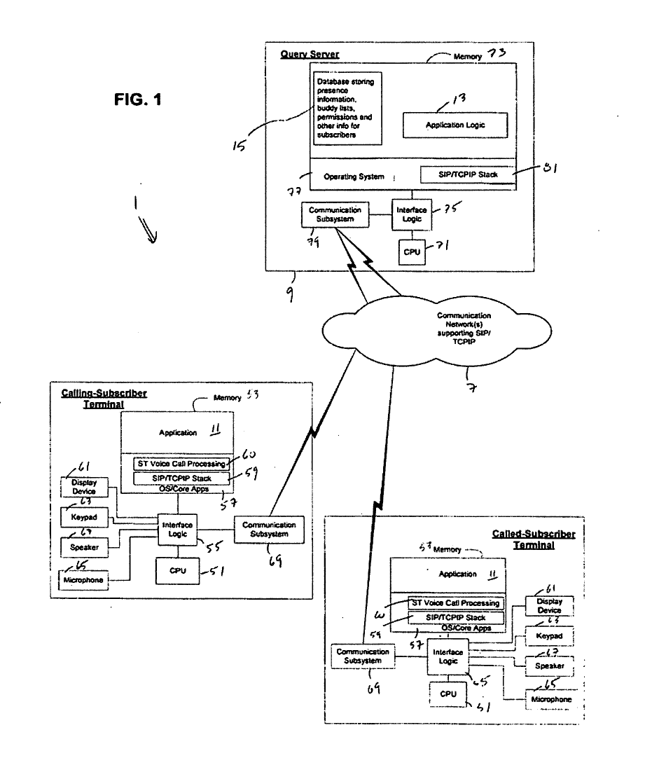

Turning now to FIG. 1, there is shown a schematic diagram of an exemplary communication system 1 that enables a ringtone or other media content to be specified by a calling-subscriber terminal device 3, and the specified media content (or a reference to such media content) included as part of a media-based call alert command communicated to a called-subscriber terminal device 5 over one or more communication networks 7. The media-based call alert command is communicated to the called-subscriber terminal device 5 prior to establishing the voice call between the calling-subscriber terminal device 3 and the called-subscriber terminal device 5, in a manner which can vary dependent upon the equipment and communication protocols of the communication network(s) 7 and the subscriber terminal devices. In many instances, such call establishment involves provisioning the communication network(s) 7 to establish communication channels over the communication network(s) 7 that allow for duplex communication between the subscriber terminal devices. The media content included in (or referenced by) the media-based call alert command is played on the called-subscriber terminal device 5 prior to (or concurrent with) the establishment of the voice call between the subscriber terminal devices. The communication of the media-based call alert command is realized as part of a service that is available to subscribers of the service. The voice call between subscriber terminal devices 3, 5 can be carried over a suitable telephony connection (e.g., a wireless telephony connection and/or a “voice over IP” data connection). In addition, the voice call between subscriber terminal devices 3, 5 can be supplemented with ancillary data communication (e.g., video data for a video call, data exchange for whiteboarding, file sharing or other collaborative features).

The subscriber terminals 3, 5 can be any of a number of communication devices including cellular handset devices, personal digital assistants, personal computers, networked kiosks, VOIP phone, traditional phone connected to a VOIP gateway, and the like. FIG. 1 illustrates, in block diagram form, the architecture of an exemplary embodiment of the subscriber terminals, including a central processor unit 51 that is interfaced to memory 53 by interface logic 55. The memory 53, which is typically realized by persistent memory (such as one or more ROM memory modules and/or one or more flash memory modules) as well as non-persistent memory (such as one or more DRAM modules), stores an operating system and core applications 57 as well as an application 11, which is referred to below as the “media-based call alert application”. The central processor unit 51 also interfaces to a display device 61 (e.g., a liquid crystal display panel), a keypad or keyboard 63 and/or other user input device (e.g., a touch screen disposed on the display device 61), a microphone 65 for voice input, and a speaker 67 for voice/audio output. The central processor unit 51 interfaces to a communication subsystem 69 that provides for bidirectional communication with the communication network 7.

A query server 9 interfaces to the network 7. FIG. 1 illustrates, in block diagram form, the architecture of an exemplary embodiment of the query server 9, including a central processor unit 71 that is interfaced to memory 73 by interface logic 75. The memory 73, which is typically realized by persistent memory (such as one or more ROM memory modules and/or one or more flash memory modules) as well as non-persistent memory (such as one or more DRAM modules), stores an operating system 77 as well as application logic 13. The operating system 77 and application logic 13 are typically stored in a storage device, such as magnetic disk drive or disk array (not shown), and loaded into memory 73 as needed. The central processor unit 71 interfaces to a communication subsystem 79 that provides for bidirectional communication with the communication network 7.

The application logic 13 of the query server 9 maintains a database 15 that stores presence information, which provides communication states associated with the subscribers of the service. Such communication states are selected from a variety of states that indicate the availability of the corresponding subscriber to receive communication as part of the service. For example, in the preferred embodiment, the presence information represents at least an “opt-in” state (meaning that the subscriber is available for voice call communication initiated as part of the service) and an “opt-out” state (meaning the subscriber is not available for voice call communication initiated as part of the service). A subscriber updates his/her presence information by execution of the application 11 on a respective subscriber terminal device, which communicates with the query server 9 to update the presence information of the subscriber maintained therein. The database 15 also maintains device information for subscribers that defines various operating parameters of the communication terminal used by the subscribers, for example, the type of the communication terminal used by the subscriber (e.g., handset model and version of operating system), the home access network used by the subscriber, the compatibility of the communication terminal used by the subscriber, and status information regarding the installation and activation of the application 11 on the communication terminal of the subscriber.

In the preferred embodiment of the invention, the database 15 of the query server 9 also maintains a buddy list for each subscriber. The buddy list for a given subscriber is created by the given subscriber and identifies other subscribers of the service that are known by the given subscriber. The buddy list can possibly identify subscribers by their mobile identifier number, screen-name, email address, etc. The buddy list for a given subscriber also includes (or points to) permission data for each subscriber on the list. The permission data, which is set by the given subscriber, allows the given subscriber to selectively allow/prohibit the receipt of media-based call alert communications originating from other subscribers in the buddy list. If the called-subscriber terminal device 5 has registered the calling subscriber as permitted to communicate only “commercial” or so-called “pre-recorded” media content (like songs and video clips from record companies and film studios), then the calling-subscriber terminal device 3 will be notified accordingly via the icon associated with that called subscriber on the calling-subscriber terminal device's buddy list, and personally recorded voice or video call alerts will not be allowed to be communicated to that called subscriber (while commercial media content will be communicated thereto). The called subscriber may configure his or her device via a graphical user interface that a calling subscriber represented in his or her buddy list can only communicated commercial media content and, further, that the commercial media content carries a specific minimum content rating (e.g. All-Ages, PG13, R-Rated, X-Rated or Unrated) to block all non-compliant or potentially offensive media content from appearing on the called subscriber terminal device. The buddy list for a given subscriber also includes (or points to) status data that provides an indication whether the other subscribers in the buddy list are allowing or prohibiting (or status unknown) the receipt of media-based call alert communications originating from given subscriber. Preferably, the buddy list for a given subscriber is created by execution of the application 11 on a respective subscriber terminal device by the given subscriber and uploaded to the query server 9 for remote storage therein. The buddy list can be downloaded to the application 11 for access by the given subscriber as needed.

In alternate embodiments, the presence information can encompass other communication services (e.g., instant messaging communication services, VOIP communication services, etc) and represent various degrees of availability of the subscriber (e.g., Unavailable, Available-Desktop, Available-Mobile, Busy, Idle (Away), Silent Mode-Desktop, Silent Mode-Mobile).

The presence information, buddy lists, permission data, device data or parts thereof can be maintained in the central registry (or possibly in a distributed registry) and updated by communication between the subscriber terminals 3, 5 and the registry via a communication interface therebetween. In such embodiments, the presence information, buddy lists, permission data, device data or parts thereof maintained in the registry can be communicated to the query server 9 via a communication interface therebetween.

In the preferred embodiment, the communication network(s) 7, the operating system 57 of the subscriber terminal devices and the operating system 77 of the query server 9 provide support for the TCP/IP networking protocol and the Session Initiation Protocol (SIP) in order set up communication sessions between either one of the subscriber terminal devices 3, 5 and the query server 9 and communication sessions between the subscriber terminal devices 3, 5. Once set up, the communication sessions employ Real-Time Transport Protocol (RTP) packets as the carrier of the information itself. Support for SIP in the communications network 7 requires proxy and registrar network elements (not shown) as is well known. Support for SIP by the subscriber terminals is realized by a SIP/TCPIP stack 59 included as part of the operating system as is well known. Support for SIP by the query server is realized by a SIP/TCPIP stack 81 included as part of the operating system as is well known.

The application 11 executing on the subscriber terminals and the application logic 13 of the query server 9 include software-based functionality for specifying media content included (or referenced by) a media-based call alert command, communicating the media-based call alert command from the calling-subscriber terminal device 3 to the called-subscriber terminal device 5 prior to establishing the voice call therebetween, and for playing the media content included (or referenced by) the media-based call alert command on the called-subscriber terminal device 5 prior to (or concurrent with) the establishment of such voice call.

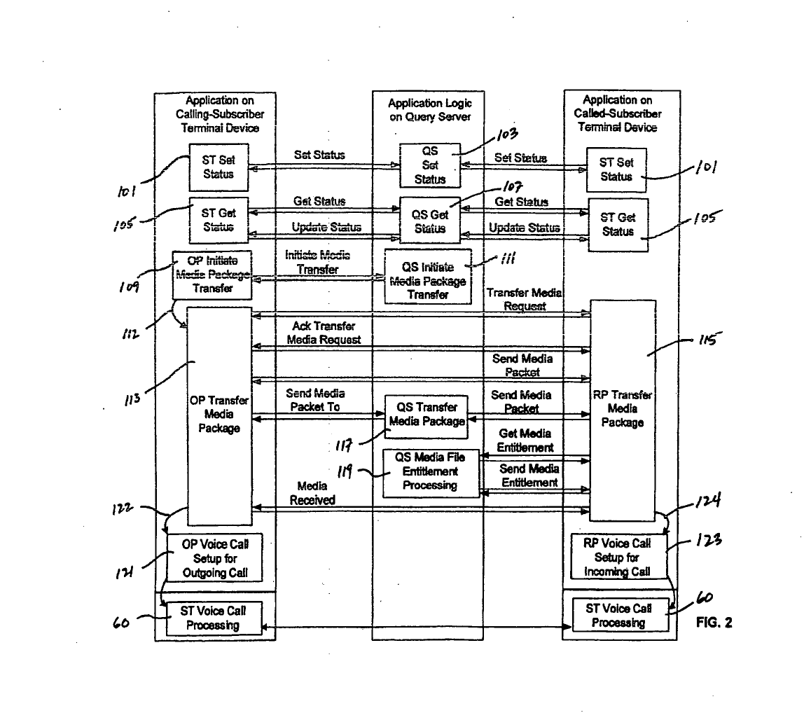

FIG. 2 illustrates software functionality of the application 11 executing on the subscriber terminals and the application logic 13 of the query server 9. The software functionality embodies a structured framework for communication of the media-based call alert command and carrying out a voice call communication process in accordance with a first embodiment of the present invention. The structured framework includes commands that are communicated as part of messages between the elements of the system. The commands convey data as well as state information between the elements of the system. Note that for simplicity of description, the functionality of the application 11 for originating calls (i.e., calling-subscriber functionality) and for receiving calls (i.e., called-subscriber functionality) is shown and described separately with respect to the calling-subscriber terminal 3 and the called-subscriber terminal device 5. However, because such subscriber terminal devices can be used as both calling- and called-subscriber terminal devices, the application logic 11 stored and executed on each respective subscriber terminal device includes the collection (e.g., union) of functions separately described herein.

The Subscriber Terminal (ST) Set Status function 101 is executed on both the calling-subscriber terminal device 3 and the called-subscriber terminal device 5 during the media-based call alert communication process. It is responsible for updating the presence information (e.g., “opt-in”/“opt-out” status) of the particular subscriber that is executing the application 11 on the respective subscriber terminal device as well as the device data of the respective subscriber terminal device. The updated presence information and device data is carried as part of a “Set Status” command communicated from the respective subscriber terminal device to the query server 9. The Query Server (QS) Set Status function 103 on the query server 9 receives and parses the “Set Status” command, collects the updated presence information and device data from the received “Set Status” command, and updates the presence information and device data stored in the database 15 for the particular subscriber in accordance with the received updated presence information, if needed.

Preferably, the database 15 is initialized such that the presence information for the particular subscriber has a system-wide default value (e.g., “opt-out” status), and the initial execution of the application 11 by the particular subscriber invokes the ST Set Status function 101 to set the presence information for the particular subscriber in the database 15 to a subscriber-modifiable default state (e.g., “opt-in”). The presence information can then be updated by subscriber interaction with a graphical user interface presented to the particular subscriber, which again invokes the ST Set Status function 101 to update the presence information for the particular subscriber in the database 15.

The ST Get Status function 105 may be executed on both the calling-subscriber terminal device 3 and the called-subscriber terminal device 5 during the media-based call alert communication process. The ST Get Status function 105 cooperates with QS Get Status Function 107 on the query server 9 to synchronize the buddy list and associated permissions data, status data, and device data of the particular subscriber that is executing the application 11 on the respective subscriber terminal device. The updated buddy list and associated permission data is carried as part of a “Get Status” command communicated from the respective subscriber terminal device to the query server 9, which updates the database 15 accordingly. Updates to the status data associated with the buddy list are carried as part of an “Update Status” command communicated from the query server 9 to the respective subscriber terminal device, which updates the status data stored on the respective subscriber terminal device as needed. In the preferred embodiment, the ST Get Status function 105 is carried out by both the calling-subscriber terminal device and the called-subscriber terminal device on a predefined, periodic basis (e.g., every 300 seconds) so as to maintain the query server 9 with up-to-date permissions and status data for subscribers of the service. The period between the ST Get Status function calls can be configurable on each subscriber terminal device and/or by a parameter setting on the query server 9.

In alternate embodiments, presence information, buddy lists, permission data, device data or parts thereof can be maintained in the central registry (or possibly in a distributed registry) and updated by communication between the subscriber terminals 3, 5 and the registry via a communication interface therebetween. In such embodiments, the presence information, buddy lists, permission data, device data or parts thereof maintained in the registry can be communicated to the query server 9 via a communication interface therebetween.

A calling subscriber initiates the communication of a media-based call alert command to a called subscriber, which is typically accomplished by user interaction with a graphical user interface displayed by the application 11 on the display device 61 of the calling-subscriber terminal device 3. In response thereto, the Originating Party (OP) Initiate Media Package Transfer function 109 is executed on the calling-subscriber terminal device 3. It communicates an “Initiate Media Package Transfer” command to the query server 9. The “Initiate Media Package Transfer” command identifies the called subscriber typically by the user name (e.g., screen name or email address assigned to the called subscriber) and can also identify the content type of the media-based call alert (e.g., a commercial audio alert-type, a commercial video alert-type, a recorded audio alert-type, a recorded video alert type, etc.). In response thereto, the QS Initiate Media Package Transfer function 111 executing on the query server 9 accesses the database 15 to retrieve the presence information and device data for the called subscriber. The query server 9 can also retrieve the permissions associated with the buddy list of the called subscriber. In distributed architectures, the query server 9 may be required to communicate with a central registry (or possibly a distributed registry) in order to retrieve the appropriate presence information, device data, buddy list, permissions data or parts thereof for the called subscriber.

The query server 9 then checks whether the presence information and/or the device data and/or the permissions data of the called subscriber indicates that the media-based call alert communication originating from the calling subscriber should be “allowed” or “blocked.” The serviceability status (i.e., “authorized” or “not-authorized”) for the media-based call alert communication is returned to the calling-subscriber terminal device 3. Such serviceability status is based upon the presence information and/or permission data and/or device data for the called subscriber (e.g., the serviceability status is “authorized” in the event that the presence information for the called-subscriber indicates the “opt-in” state, the permissions data for the called subscriber indicate that media-based call alert communication originating from the calling subscriber should be “allowed”, and the device data for the called subscriber indicates that the appropriate application is installed and activated on the called subscriber terminal device and thus communication of the media-based called alert communication should be possible; or the serviceability status is “not-authorized” in the event that the presence information for the called-subscriber indicates the “opt-out” state or the permissions data for the called subscriber indicate that media-based call alert communication originating from the calling subscriber should be “blocked”, or the device data for the called subscriber indicates that the appropriate application is not installed or not activated on the called subscriber terminal device and thus communication of the media-based called alert communication is not possible). As described herein, the permissions data for the called subscriber can pertain to all media-based call alerts originating from the calling subscriber; alternatively, the permissions data for the called subscriber can pertain to one or more particular content-types of the media-based call alerts originating from the calling subscriber as described herein. In the alternative case, the permissions data corresponding to the particular content-type of the media-based call alert specified by the calling subscriber is used to determine the serviceability status of the called subscriber.

The OP Initiate Media Package Transfer function 109 determines if the returned status indicates that the called subscriber is “serviceable”, and if so initiates the OP Transfer Media Package function 113 as described below. The transition from the OP Initiate Media Package Transfer function 109 to the OP Transfer Media Package function 113 is designated by arrow 112. If the returned status indicates that the called subscriber is “not serviceable”, the OP Initiate Media Package Transfer function 109 can display such status to the calling subscriber on the display device 61 and/or possibly raise other alerts on the calling-subscriber terminal device 3, and then end the processing of the media-based call alert communication to the called subscriber. It is also possible for the presence information and/or the device data and/or the permissions data of the called subscriber to be returned from the query server 9 to the calling-subscriber terminal device 3 and used by the called-subscriber terminal device 3 to determine the serviceability status of the calling subscriber in a manner similar that described above for the query server 9.

Note that in response to the “Initiate Media Package Transfer” command, the QS Initiate Media Transfer function 111 may initiate an Accounting Function (not shown) that performs the following tasks: (i) creating a transaction/call record for reporting purposes and billing purposes, if necessary, and/or (ii) validating that the calling subscriber and the called subscriber can be correctly billed for the media-based call alert communication of the present invention, if necessary.

The OP Transfer Media function 113 is executed on the calling-subscriber terminal device 3. It communicates a “Transfer Media Request” command to the called-subscriber terminal device 5. The “Transfer Media Request” command preferably includes the following: (i) a file name and possibly corresponding file type of one or more media files that make up the media-based call alert, (ii) the size of these media file(s), and (iii) digital rights management (DRM) information for the media file(s). Such DRM information preferably includes:
permissions/entitlements that designate consumption rights or restrictions imposed on these media file(s), and
URLs (or IP addresses) for one or more servers for obtaining keys for decrypting the media file(s) that make up the media-based call alert and for obtaining the requisite permissions/entitlements.
   The permissions/entitlements that can be used to designate consumption rights or restrictions imposed on the media file(s) of the media-based alert preferably include the following:
Play, No Save (the called-subscriber terminal device can play the media content, but cannot save the media content locally. Ephemeral copy only);
Play, Save, Unlimited Use, No Forward (the called-subscriber terminal device can play the media content for an unlimited number of times, and can use media for intended utility (e.g. media-based call alert), but cannot forward or copy the media content off of the called-subscriber terminal device);
Play x times, Save, Unlimited Use, No Forward (similar to Play, Save, Unlimited Use, No Forward, but the called-subscriber terminal device can only play the media content x number of times, then the media content is permanently deleted from device);
Play until dd-mm-yyyy, Save, Unlimited Use, No Forward [similar to Play, Save, Unlimited Use, No Forward, but the media content is permanently deleted from device after dd-mm-yyyy);
any of the above with Limited Use (the media content can only be used for specific use or a specific number of times, e.g., as media-based call alert or only 10 times);
any of above with pass along/forward rights (the media content can be passed to another device in a super distribution scheme; note that the actual media is not transferred—what is sent to recipient device is an invitation to download appropriate entitlement and media.

The consumption rights or restrictions can also allow the media content to be played only in a specific sequence of actions by the calling subscriber or called subscriber, or only in a specific sequence of plays of other media content items, or only in a predetermined combination of both. For example, such consumption rights can dictate that:
the calling subscriber must watch an advertisement before or after the media-based alert may be pushed;
the called subscriber must respond to an advertisement that plays before or after all or part of the media content plays;
the media content embodied in the media-based call alert may itself be an advertisement that requires a response from the calling subscriber or the called subscriber, or both, in order for another event (like another part of the media content to play, or to open a media-sharing data connection between devices) to take place;
the called subscriber must “unpause” an incoming “paused” call;
the called subscriber must retrieve a multimedia announcement that is stored on the device or on the server as a result of encountering that the called subscriber terminal device is in “silent mode” at the time of the incoming call;
the device must be within a certain proximity or range of a local network before the media content will play (it could contain an audio, rf or light signal sequence that can unlock an atm, door or website, as an example).

The RP Transfer Media Package function 115 executing on the called-subscriber terminal device 5 processes the “Transfer Media Request” command to determine if the media file(s) identified therein can be received and processed by the called-subscriber terminal device 5, and returns the “Ack Transfer Media Request” command to the calling-subscriber terminal device 3. The “Ack Transfer Media Request” command preferably includes the following: (i) a preferred format for the media file(s), (ii) available memory on the called-subscriber terminal device 5, and (iii) acknowledgement of ability to comply with the DRM restrictions imposed on the media file(s).

Upon receipt of the “Ack Transfer Media Request” command, the OP Transfer Media Package function 113 executing on the calling-subscriber terminal device 3 validates the information supplied therein for compliance. Such validation preferably confirms that the called-subscriber terminal device 5 can accept and consume the media file(s) that make up the media-based call alert as intended and in the format provided by the calling-subscriber terminal device 5. If such validation is successful, the OP Transfer Media Package function 113 initiates communication of the “Send Media Packet” command to the called-subscriber terminal device 5. The “Send Media Packet” command preferably includes the following: (i) the media file(s) that make-up the media-based call alert in encrypted form, (ii) meta-data relevant to these media file(s) (e.g., name, creator(s), performer(s) etc.), and (iii) DRM information for the media file(s) as described above. Upon receipt of the “Send Media Packet” command, the RP Transfer Media Package function 115 initiates communication of a corresponding acknowledge command that is returned back to the calling-subscriber terminal device 3. Upon receipt of this acknowledge command, the OP Transfer Media Package function 113 is placed into a wait state pending receipt of the “Media Received” command to be issued by the RP Transfer Media Package function 115 as described below.

In the event that the validation of the “Ack Transfer Media Request” command fails, the OP Transfer Media Package function 113 can display such status to the calling subscriber on the display device 61 and/or possibly raise other alerts on the calling-subscriber terminal device 3, and then end the processing of the media-based call alert communication to the called subscriber.

If the processing of the “Ack Transfer Media Request” command indicates that the called-subscriber terminal device 3 requires the media-based caller alert in a different format, the OP Transfer Media Package function 113 can initiate the “Send Media Packet To” command to the query server 9. The “Send Media Packet To” command preferably includes the following information: (i) the address of the called-subscriber terminal device 5, (ii) optionally, details about the media file(s) that make up the media-based call alert, (iii) optionally, the media file(s), (iii) the required format for the media file(s) as requested by the called subscriber in the “Ack Transfer Media Request” command, and (iv) DRM information for the media file(s) as described above. Upon successful receipt of the “Send Media Packet To” command, QS Transfer Media Package function 117 executing on the query server 9 sends a corresponding acknowledge command directed back to the calling-subscriber terminal device 3. Upon receipt of this acknowledge command, the OP Transfer Media Package function 113 is placed into a wait state pending receipt of the “Media Received” command to be issued by the RP Transfer Media Package function 115 as described below.

The QS Transfer Media Package function 117 operates to either (i) transcode the media file(s) received from the calling-subscriber terminal device 3 into the suitable format as identified by the calling-subscriber device 3 in the “Send Media Packet To” command or (ii) acquire a new copy of the media file(s) in the suitable format. The new copy can be acquired from a media store maintained by the query server 9 or a media store operably coupled thereto. Upon generating (or acquiring) the media file(s) in the suitable format, the QS Transfer Media Package function 117 initiates the communication of the “Send Media Packet” command (which is described above in detail) to the called subscriber terminal device 5. Upon receipt of the “Send Media Packet” command, the RP Transfer Media Package function 115 initiates communication of a corresponding acknowledge command directed back to the query server 9, thereby indicating successful delivery of the “Send Media Packet” command to the called-subscriber terminal device 3.

After issuing the acknowledge command in response to successful delivery of a “Send Media Command” communicated by the calling-subscriber terminal device 3 or by the query server 9, the RP Transfer Media Package function 115 issues a “Get Media Entitlement” command to the query server 9. The QS Media File Entitlement Processing function 119 executing on the query server 9 receives the “Get Media Entitlement” command and obtains the necessary decryption key(s) and DRM license data (collectively media file entitlement data) associated with the media file(s) of the media-based call alert. Such media file entitlement data can be stored locally on the query server 9 or obtained from another server operably coupled thereto. Upon acquisition of the necessary media file entitlement data, the QS Media File Entitlement Processing function 119 forwards the media file entitlement data to the called-subscriber terminal device 5 as part of a “Send Media Entitlement” command communicated thereto. Alternatively, the Media File Entitlement Processing function 119 can be carried out as part of the called-subscriber terminal device 5 to interact with the appropriate servers to acquire the necessary media file entitlement data for the media file(s) that make up the media-based call alert.

The RP Transfer Media Package function 115 receives the “Send Media Entitlement” command and the media file entitlement data included therein. Upon receiving the “Send Media Entitlement” command, the RP Transfer Media Package function 115 initiates communication of a “Media Received” command to the calling-subscriber terminal device 3. As described above, the OP Transfer Media Package function 113 is placed into a wait state for receipt of the “Media Received” command. Upon receipt of this “Media Received” command, the OP Transfer Media Package function 113 initiates communication of a corresponding acknowledge command that is directed back to the called-subscriber terminal device 5 and then initiates the OP Voice Call Setup function 121. The transition from the OP Transfer Media Package function 113 to the OP Voice Call Setup function 121 is designated by arrow 122.

Upon receiving the acknowledge signal that is returned from the calling-subscriber terminal device 3 indicating receipt of the “Media Received” command, the RP Transfer Media Package function 115 initiates the RP Voice Call Setup function 123. The transition from the RP Transfer Media Package function 115 to the RP Voice Call Setup function 123 is designated by arrow 124.

The OP Voice Call Setup function 121 cooperates with the ST Voice Call Processing logic 60 executing on the calling-subscriber terminal device 3 in order to provision a voice call to the called-subscriber terminal device 5 using available network resources. Such functionality may tear down the SIP session between the calling and called-subscriber terminal devices 3, 5 before provisioning the voice call. Such provisioning is preferably realized by passing a phone number (or other identifier) of the called-subscriber terminal device 5 to the ST Voice Call Processing logic 60 via an application programming interface. In the preferred embodiment, the ST Voice Call Processing logic 60 is realized as part of the operating system 57 of the subscriber terminal and embodies the necessary functionality in provisioning the voice call between the calling subscriber terminal 3 and the called subscriber terminal device 5. The voice call can be accomplished over a cellular network, a data packet network (e.g., VOIP call over the Internet), or other suitable communication network.

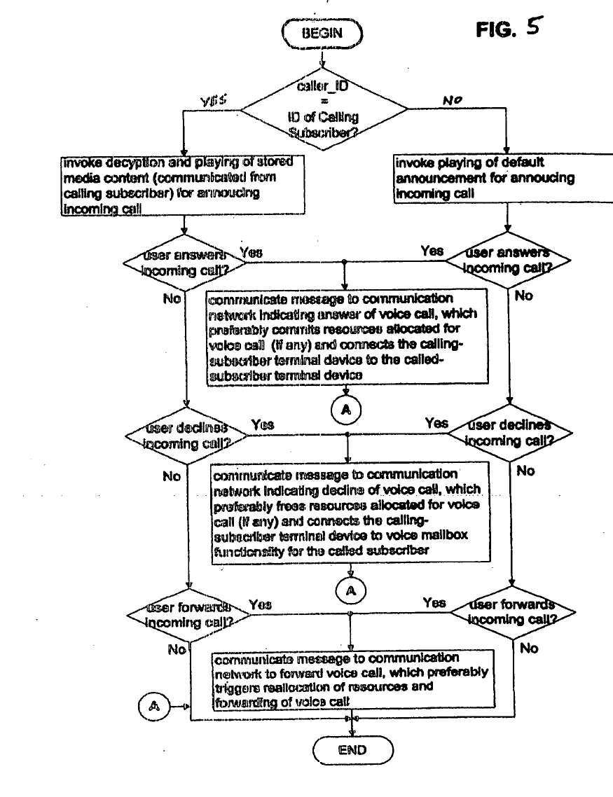

The RP Voice Call Setup function 123 cooperates with the ST Voice Call Processing logic 60 executing on the called-subscriber terminal device 5 such that called-subscriber terminal device 5 is placed in “incoming call wait mode”. In this mode, the processing of all incoming voice calls is diverted to the RP Voice Call Setup function 123. More particularly, the ST Voice Call Processing Logic 60 passes caller identifier information for each incoming call to the RP Voice Call Setup Function 123. The RP Voice Call Setup function 123 validates this caller identifier information against caller identifier information that it has stored for the calling subscriber. If the caller identifier information for the incoming call does not match the stored caller identifier information, the RP Voice Call Setup function 123 releases the call such that the call is handled by the ST Voice Call Processing Logic 60. If the caller identifier information for the incoming call does match the stored caller identifier information, the RP Voice Call Setup function 123 bypasses the traditional incoming call processing and preferably invokes the appropriate DRM client on the called subscriber terminal 5 to use the decryption key of the media file entitlement data (which is sent as part of the “Send Media Entitlement” command as described above) to decrypt the media file(s) that make up the media-based call alert. The DRM client passes the media file(s) in decrypted form or encrypted form as appropriate to the media player (which is typically stored as part of the core applications and operating system 57 of the called-subscriber terminal device 3). In this manner, the media player executing on the called-subscriber terminal device 5 plays the media file(s) that make up the media-based call alert as received by the RP Transfer Media Package function as described above. The DRM client cooperates with the media player to conform to the consumption restrictions (e.g., execute and not save) imposed on the media file(s) as dictated by the DRM license data associated therewith. An example of such processing is illustrated in the flow chart of FIG. 5.

The RP Voice Call Setup function 123 also invokes a graphical user interface that allows the called subscriber to select one of various actions with respect to the incoming call (Answer, Decline, Forward, etc). User selection of a given action causes the RP Voice Call Setup function 123 to cooperate with the ST Voice Call Processing logic 60 to carry out the desired action (e.g., answer the call, decline the answering of the call, forward the call to another number). In this manner, the media file(s) that make up the media-based call alert is played on the called-subscriber terminal device 5 prior to (or concurrent with) the establishment of the voice call between the subscriber terminal devices 3, 5. The playing of the media-based call alert is an announcement of the incoming voice call initiated by the calling subscriber.

In the preferred embodiment, the application 11 may be discovered and installed onto a subscriber terminal device in one of four ways:
i) a user discovers the application while browsing through the application icons, or through the pre-installed applications, on his or her device's menu. Alternatively, the user many discover additional menu item(s) relating the application when using the contact list (or phone book) application on the device. In this configuration, first-time execution of the application 11 or the applicable menu item will trigger the initialization (set up) process as described below.
ii) user discovers the application 11 displayed on a Web site, a Wap site, or other mechanism for public distribution therefrom; promoted in text or instant message or on a client application; promoted on an traditional-media advertisement (print, TV or radio); or promoted on a remote vending terminal (e.g. a WiFi or Bluetooth kiosk). The user orders the application 11, which results in the application 11 being downloaded onto the user's device where it will automatically install and attempt to commence the initialization (set up) process, as described below.
iii) the application 11 is promoted by a subscriber who wants to use the application 11 to place a call to the user; for example, the user may receive a textual message (via SMS, instant message or a pop-up in a client application) saying “<Calling Party's number> is trying to connect with you with a ‘Push Ringer Media Call.’ To accept please download (free) and install the ‘Push Ringer Media Call’ application—Accept/Decline”. Acceptance by the user results in the application 11 being downloaded onto the user's device where it will automatically install and attempt to commence the initialization (set up) process, as described below. During this process the calling subscriber preferably is displayed a message providing an indication that the user has accepted an invitation to download and install the application 11 and to stand-by for connection.
iv) a user whose device does have the application 11 pre-installed (or otherwise installed) but has not been initialized (set up), is a recipient of an attempted media-based call alert communication. The application 11 when installed but not initialized will be configured to listen for “Transfer Media Request” commands. Upon receipt of a “Transfer Media Request command, the application 11 displays a graphical user interface that notifies the user of the incoming media-based call alert communication and that provides various user-selectable actions (e.g., a graphical pop-up saying “<Calling Party's number> is sending you with a ‘Push Ringer’ and offering the following icons: {Play}, {Decline}, {Pause} or {More}). If the appropriate user-selected action (e.g., {Play}) is selected, the application 11 carries out the required media-based call alert communication processing (e.g., “Ack Transfer Media Request” command, “Send Media Packet” command, “Get/Send Media Entitlement” commands, “Media Received” command as described above) that communicates the pushed media content to the called-subscriber terminal 5 and plays the pushed media content on the called-subscriber terminal 5 prior to (or concurrent with) the establishment of the voice call between the subscriber terminal devices 3,5. If the user declines acceptance of the media-based call alert communication (e.g., selects {Decline}), any download or initialization of the application 11 or delivery of Transfer Media Request command will be terminated, if needed, and the calling subscriber will be prompted with an appropriate display prompt that indicates that media-based call alert communication has been declined and that allows for the user to make a regular voice call to the called subscriber, as otherwise intended by the user. In this scenario, the called subscriber, who declined, is preferably sent an SMS message explaining the service and how to download the application 11 for future use. If the calling subscriber attempts to initiate media-based call alert communications to a party who does not have a compatible device, the calling subscriber can be prompted with a display indicating that such media-based call alert communication is not possible and that allows for the user to make a regular voice call to the called subscriber. If the user selects the {Pause} option, the media-based call alert will remain in the user's device's memory and the application will present a persistent {Play} icon that allows the user to play the media-based call alert at a later time, and the application will notify the calling subscriber that the user has paused the media-based call alert and notifies the calling subscriber again when the user has played the media-based call alert. If the user selects the {More} option, the user will be presented with other optional responses to the media-based call alert which may vary from time to time or by communication type (voice call, IM, PTT or basic media push communication).

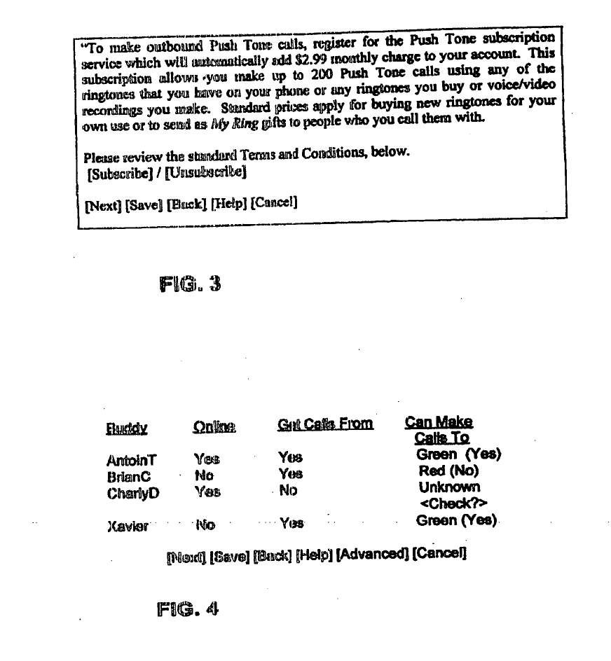

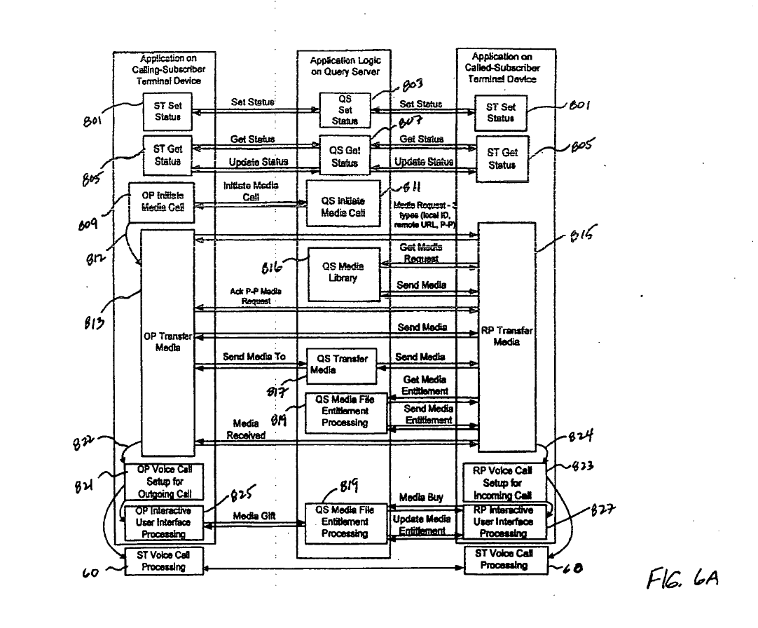

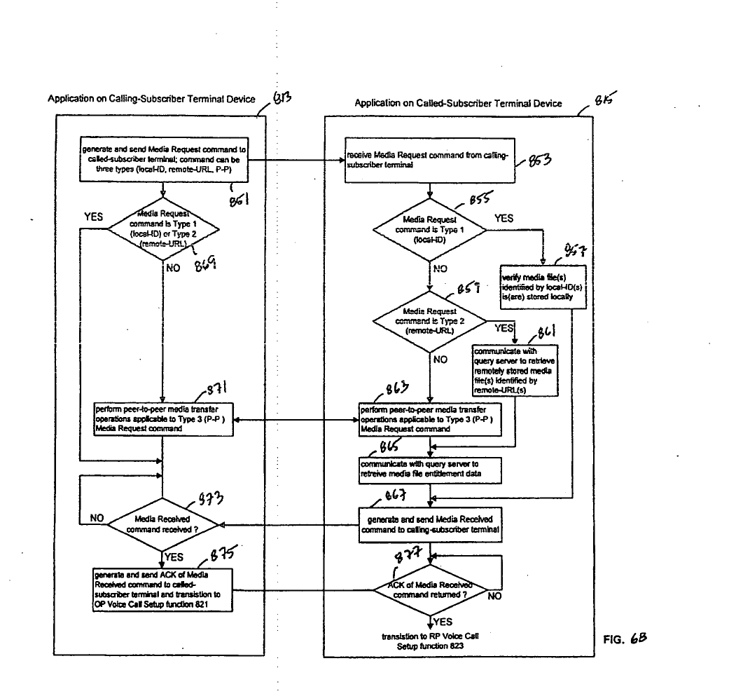

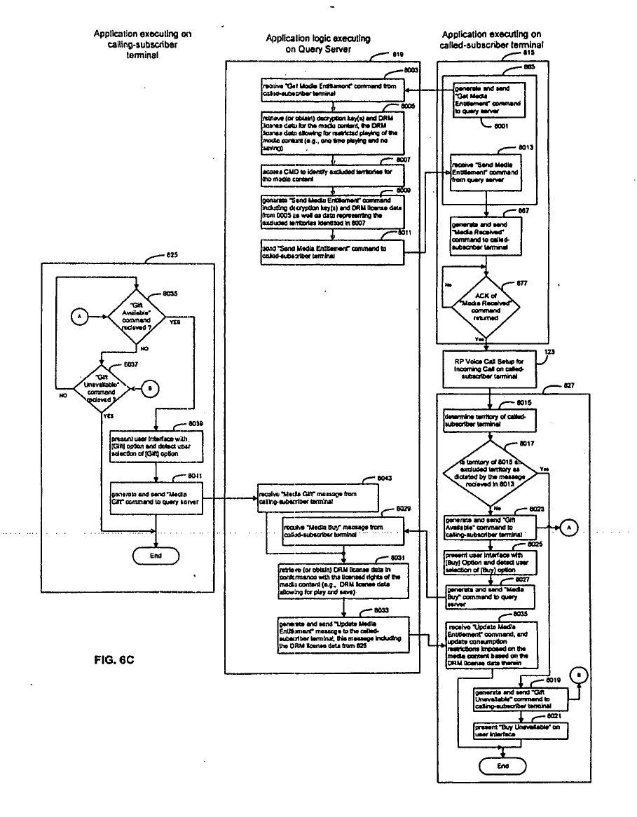

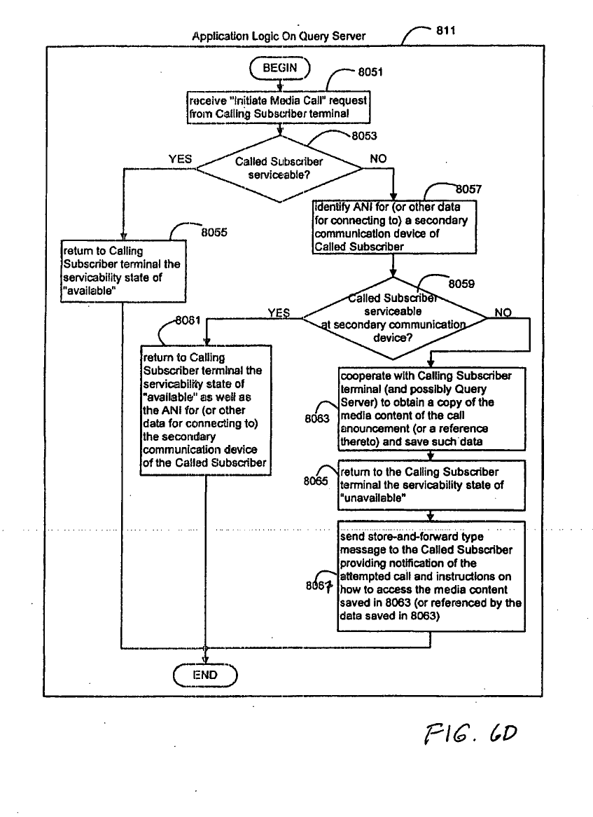

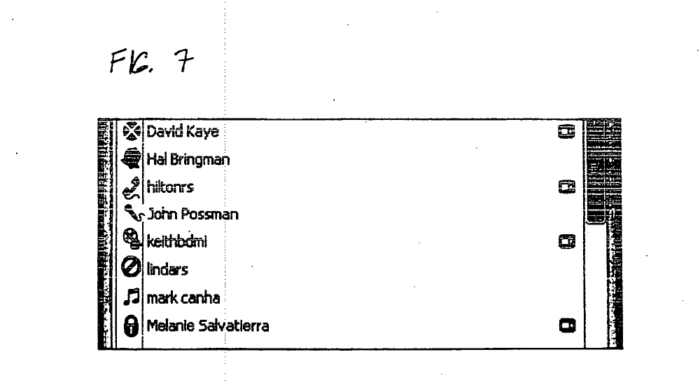

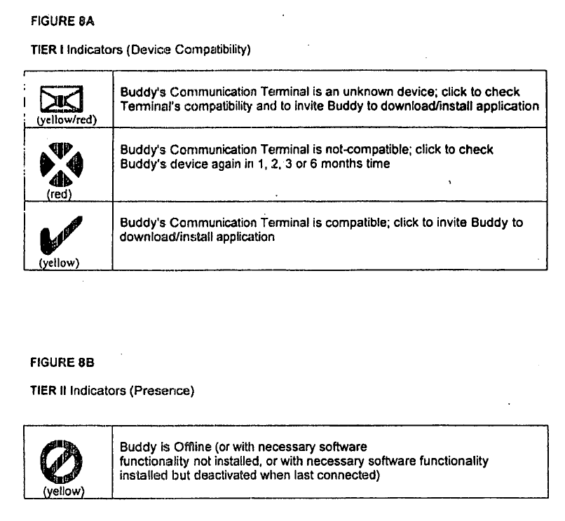

In the preferred embodiment, there are two different types of media-based call alert communications: “My Ring”-type pushed media communications and “Record Ringer”-type pushed media communications. The “My Ring”-type pushed media communication employs a media file whose content (e.g., audio, graphical or video content) is available from a generally-available public source. The “Record Ringer”-type push media communication employs a media file whose content (e.g., audio, graphical or video content) is generated or available from a private source, such as from media content stored on/generated by a particular subscriber terminal. In this preferred embodiment, upon installation of the application 11, the application 11 is enabled to only receive “My Ring”-type or “Record Ringer”-type pushed media communications. The user must first register to become a subscriber to be able to make/originate My Ring”-type or “Record Ringer”-type pushed media communications. This can be accomplished in the exemplary architecture of FIG. 2 (or the exemplary architecture of FIG. 6A) by initially disabling the calling subscriber functionality show therein and described above, and enabling such calling subscriber functionality upon registration. Once registered, the user will immediately be able to select any of the audio, graphical or video files on his or her device for use as media content in originating “My Ring”-type pushed media communications. An exemplary display window for registering and subscribing to a media-based call alert communication service as described herein is shown in FIG. 3.

As described above, the application 11 executing on a subscriber terminal device maintains a buddy list graphical user interface, which allows the subscriber to see presence information associated with other known subscribers, to manage who can make media calls to the subscriber (e.g., selectively block or enable media-based call alert communications from other known subscribers), and to see whether or not the subscriber is blocked or enabled from making media-based call alert communications to other known subscribers. The buddy list can also provide an indication if other known users (who may or may not be subscribers) have a compatible device for receiving media-based call alert communications.

An exemplary buddy list graphical user interface is shown in FIG. 4. Each buddy in the list is displayed in the first column and can be a subscriber or a non-subscriber to the service. Names (or other identifiers) can be added, renamed or removed from the buddy list. Preferably, the buddy list is initially populated with all names in a phone book or other data structure maintained by the operating system and core applications 57 of the device. Note that the buddy list may be stored off-device by the service provider.

The second column of the buddy list of FIG. 4 provides the presence information for each buddy. More particularly, if the user has an “opt-in” status, “Yes” is displayed for that buddy in the second column of the buddy list. If the user has an “opt-out” status, “No” is displayed for that buddy in the second column of the buddy list.

The third column of the buddy list of FIG. 4 allows the subscriber to selectively enable or block the receipt of media-based call alert communications for each respective buddy on the list. When a subscriber selects “Yes” for the third column entry for a given buddy, media-based call alert communications from the given buddy are received. Conversely, when a subscriber selects “No” for the third column entry for the given buddy, media-based call alert communications from the given buddy are blocked.

The fourth column of the buddy list of FIG. 4 provides indications whether or not the subscriber is blocked or enabled from making media-based call alert communications to buddies on the list. A “Red (No)” indicator in the fourth column entry corresponding to a given buddy represents that the subscriber is blocked from making media-based call alert communications to the given buddy. A “Green/(Yes)” indicator in the fourth column entry corresponding to a given buddy represents that the subscriber is allowed to make media-based call alert communications to the given buddy. An “Unknown/<Check?>” indicator in the fourth column entry corresponding to a given buddy represents that it is unknown whether the subscriber is allowed to make media-based call alert communications to the given buddy. Note that the subscriber can selecting <Check?>, which initiates a media-based call alert communication to the Buddy with the intention of both technically probing the capability of that Buddy's device and requesting permission to make media-based call alert communications to that Buddy's device.

Note that the “Advanced” option is only available to subscribers and allows for more detailed control over permissions, such as what kinds of media calls the subscriber will accept from Buddies (e.g., Accept All (default), Decline All Record Rings, Decline All My Rings). The subscriber can also set usage rights for his or her outgoing media-based call alert communications. For example, for “Record Ring”-type pushed media communication, such permissions can selectively allow/block the buddy from saving the recorded media content and/or can selectively allow/block the buddy from forwarding the recorded media content.

In the preferred embodiment, the application 11 provides a graphical user interface that makes the initiation of media-based call alert communications easy to accomplish. The first step is to click on a name/number to contact from the Phone Book or the Buddy List, which results in an extended option menu being displayed that allows for user selection of a “Normal”<default> media-based call alert communication (e.g., “My Ring”-type or “Record Ringer”-type pushed media communication).

If the “Normal” selection is made, a regular call is made to the user/buddy's phone will ring with the ringtone played in accordance with the voice call processing functionality of the user's/buddy's phone.

If the “My Ring”-type selection is made, the user interacts with a graphical user interface to select media content (audio file or video file) from the media store on the subscriber's device. Preferably, the graphical user interface presents the user with selection options including “Same”, “New” (default) or “Search” (or “Shop”). The result of each selection is as follows:

The “New” display pops up a browser set to the media directory(ies) on the subscriber's device and with which the subscriber may browse to any particular file in his or her media directory; with the selection of each title an option to “Preview” and “Use” will appear. If the desired media content cannot be found, the browser will offer the option to “Search” (or “Shop” in) a content store for other media content that can be purchased and used. As soon as “Use” is selected for media content, the selected media content is integrated as part of the “My-Ring”-type pushed media communication as described above.

The “Same” display selects the media content that the calling subscriber had selected before for this particular Buddy; if no prior selection was made, the “Same” selection will operate the same as “New”. The selected media content is integrated as part of the “My-Ring”-type pushed media communications as described above.

The “Search” display pops up an integrated content storefront offering a list of the “Top 10 Choices” (displayed from local data while the application connects in the background to a fully searchable list of titles). The 11th choice on the “Top 10 Choices” list is “Top Categories” the selection of which offers five top sub-categories of media content, including “Top Songs”, “Top Seasonal”, “Top Greetings”, “Top Film/TV” and “Top Humor” sub-categories each of which displays ten titles; with each title is the option to “Preview”, the purchase price and “Buy”. As soon as media content is purchased (selects “Buy”), “Buy for Me” or “Buy for Buddy (Gift)” options pop up. If “Buy for Me” is selected, the title is downloaded to the subscriber's device, and the selected media content is integrated as part of the “My-Ring”-type pushed media communications as described above. From then on, until a different title is selected for making media-based call alert communications to that Buddy, that title will appear as the “Same” title selection when the subscriber calls the same Buddy or number. If “Buy for Buddy (Gift)” is selected, the selected media content is integrated as part of the “My-Ring”-type pushed media communications as described above. Note that during and after the particular media-based call alert communication, the called subscriber is preferably offered the option to “Save (Gift)” the content title.

If the “Record Ringer”-type selection is made, the graphical user interface is updated to prompt the user to select a recording mode (e.g., “Record Audio” mode, “Record Video” mode, possibly “Record Streaming Audio” mode, and possibly “Record Streaming Video” mode), or to chose or upload a graphic. Each audio or video selection will open up a recorder screen and begin recording the selected source while displaying {Stop} and {Quit} buttons.

In the “Record Audio” mode, recording commences immediately using the device's microphone, displaying two new options on the calling subscriber's device—{Stop} and {Quit}. An additional option button will allow the subscriber to take a picture, or select one from the photo library on his or her device, for display on the called subscriber's device. In the “Record Video” mode, recording commences immediately using the device's video camera, displaying two new options on the calling subscriber's device—{Stop} and {Quit}. Recordings are limited to a maximum period of time, e.g., 15 or 30 seconds. After the recording is complete, the application 11 will offer the option to “Review” or “Use” (“Use” is the default). “Review” will offer you the option to “Record Again” or “Use” (“Use” is the default). If the user selects “Use”, the recorded media content is integrated as part of the “Record Ringer”-type pushed media communications as described above.

In the preferred embodiment, any telephony device can experience an incoming call mediated by the media-based call alert application as described herein, provided that the device has compatible equipment, the application has been downloaded and installed, and media-based call alert communications have not been blocked by the calling subscriber. Once a media-based call alert communication has been initiated from the calling subscriber's side, the calling subscriber will listen on the line until the called subscriber has made one of several possible responses to the media-based call alert communication based on the called subscriber's equipment capabilities and preferences. On the calling subscriber's device, all incoming media-based call alerts will play once through and will then loop until the called subscriber responds (e.g., to Accept, Decline, Pause) or the call is transferred to voicemail. The media-based call alerts are programmed to play (immediately, or after being paused) on the called subscriber's device for only one alert performance session (which could encompass multiple play throughs) and are then automatically delete, except in the case where a “Record Ringer”-type announcement is saved for later review.

On the called subscriber device, while the incoming media-based call alert is playing, the graphical user interface presented to the called subscriber will preferably display the following options for response: {Accept}, {Pause}, {Snooze} {Decline} and {Block}. Each of these options triggers a further action, as follows.

The {Accept} option accepts the voice call (e.g., answers the phone) and pops up {Disconnect}, {Forward} and {Block} options for the in-call phase.

The {Pause} option pauses the playback of the incoming media-based call alert and pops up {Unpause/Resume}, {Accept}, {Disconnect} and {Block} on the display window of the called-subscriber terminal device 5 and preferably notifies the calling subscriber on his or her display that the call request is on hold.

The {Snooze} option declines the call and the connection and connects the calling subscriber and the called subscriber five, ten or fifteen minutes later (as determined by the setting on the called subscriber's application) and notifies the calling subscriber on his or her display device that the call will be reconnected in five, ten or fifteen minutes.

The {Decline} option declines the call with no explanation to the calling subscriber.

The {Block} option declines the call and updates the permissions on the called subscriber's device such that the calling subscriber is blocked from making media-based call alert communications to the called subscriber. The called subscriber can re-enable the calling subscriber's permission at any time by management of the buddy list as described above.

In certain situations, {Other} or {More} may appear as an additional option to offer the user additional responses, including transmitting the other party one of a selection of “canned” textual messages (e.g., “Can't Talk Now”) that will appear on the display screen of the recipient's device.

At the termination of each media-based call alert mediated call, the called subscriber is preferably presented with a graphical user interface that enables the called subscriber to buy, save and/or forward the media content communicated thereto as the media-based call alert. More particularly, the graphical user interface preferably displays a {Save/Buy} option, a {Save/Gift} option, a {Save} option, and a {Forward} option.

The {Save/Buy} option allows the called subscriber to buy and save the media content presented by the calling subscriber for the called subscriber to keep and use in accordance with the DRM license data associated therewith. In this way so-called viral or pass-along marketing of media content is built into the service where applicable, and calling subscribers may be rewarded for content sales resulting from called subscriber purchases with loyalty points that can be redeemed against future media call purchases or services or premium access to other device-based services.

The {Save/Gift} option allows the called subscriber to save the media content presented by the calling subscriber for the called subscriber to keep and use in accordance with the DRM license data associated therewith in the event that it has been gifted by the calling subscriber (or possibly gifted by a marketing service that gifts media content to select subscribers).

The {Save} option applies to “Recorded-Ring”-type pushed media communications and allows the called subscriber to save the media content of the media-based call alert in the event that the calling subscriber has set “Save” rights for this called subscriber to allow for saving the calling subscriber's recordings.

The {Forward} option applies to “Recorded-Ring”-type pushed media communications and allows the called subscriber to forward the media content of the media-based call alert depending on the intent of the calling subscriber and the associated DRM rights and permissions programmed into the underlying media content.

On the calling subscriber side, once the media-based call alert communication has been initiated, all status and progress information generated and/or captured by the query server 9 may be communicated to the calling-subscriber terminal device 3 where a user interface on the display screen of that device can indicate applicable status or progress information and optionally provide instances of response or interactivity to the status or progress information.

For example, in a case wherein the called subscriber {Decline} the attempted media-based call alert communication, the calling subscriber may be offered a pop-up button on the user Interface to allow him or her to save the media announcement on the network for later re-use or to re-try the media-based call alert communication with a {Urgent} notice.

In another example, in a case wherein the called subscriber places the incoming media-based call alert communication on {Pause}, the calling subscriber may be offered a pop-up button on the user interface to indicate to him or her that the called subscriber has the media-based call alert communication temporarily suspended, or to allow the calling subscriber to change media-based call alert communication to a {Snooze} connection attempt that will be automatically re-attempted by the query server 9 at a later time (e.g., 2, 5, 10, 15 or 30 minutes later).

In yet another example, in a case wherein the called subscriber has set up a particular image, sound or video clip in a “ringback tone” type of configuration, the calling subscriber may be displayed that particular image, sound or video clip on the user interface while the calling subscriber is waiting for the called subscriber to respond to the incoming media-based call alert communication. The communication of the ‘ringback tone’ between the called subscriber terminal and the calling subscriber terminal may also carry data that represents one or more interactive messages or elements (e.g., “is this call important? (Yes/No)”) that is displayed on the user interface of the calling subscriber terminal. Such data can be communicated from the called subscriber terminal to the calling subscriber terminal at the option of the called subscriber via user interaction in conjunction with the incoming media-based call alert communication (or possibly by setting parameters associated with incoming media-based call alert communications for all users and/or for individual subscribers on the buddy list of the called subscriber). The calling subscriber can respond to the interactive message (“Yes”—the call is important) and the response communicated from the calling subscriber terminal to the called subscriber terminal, where it is displayed to the called subscriber. The called subscriber can then use the calling subscriber's response in deciding the called subscriber's response (e.g., {Accept}, {Pause}, {Snooze} {Decline} and {Block}) for the incoming media-based call alert communication as described above.

In other example, other types of progress reporting and interactive options for the calling subscriber may be offered that are peculiar to the kind of media-based call alert communication that is made.

FIG. 6A illustrates an alternative embodiment of software functionality of the application 11 executing on the subscriber terminal devices and the application logic 13 of the query server 9. The software functionality embodies a structured framework for communication of the media-based call alert command and carrying out a voice call communication process in accordance with a second embodiment of the present invention. The structured framework includes commands that are communicated as part of messages between the elements of the system. The commands convey data as well as state information between the elements of the system. Note that for simplicity of description, the functionality of the application 11 for originating calls (i.e., calling-subscriber functionality) and for receiving calls (i.e., called-subscriber functionality) is shown and described separately with respect to the calling-subscriber terminal device 3 and the called-subscriber terminal device 5. However, because such subscriber terminal devices can be used as both calling- and called-subscriber terminal devices, the application logic 11 stored and executed on each respective subscriber terminal device includes the collection (e.g., union) of functions separately described herein.

The application 11 executing on both the calling-subscriber terminal device 3 and the called-subscriber terminal device 5 each maintain a common library of media content items stored thereon (e.g., in persistent memory) with identifiers assigned thereto. The calling subscriber can specify one of the media content items of the library as the media content of a media-based call alert. The identifier assigned to the specified media content item is communicated by the calling-subscriber terminal device 3 to the called-subscriber terminal device 5 as part of a “local-ID” type Media Request command prior to establishing the voice call between the calling-subscriber terminal device 3 and the called-subscriber terminal device 5. The called-subscriber terminal device utilizes the identifier of the “local-ID” type Media Request command to access the corresponding media content item stored locally in its library of media content items, and then plays the corresponding media content item on the called-subscriber terminal device 5 prior to (or concurrent with) the establishment of the voice call between the subscriber terminal devices as described below in more detail.

The query server 9 can maintain a library 816 of media content items with URL identifiers assigned thereto. Alternatively, the library 816 can be realized by one or more remote content sources and/or can interface to one or more remote content sources for distributed management of such media content. The calling subscriber can specify one of the media content items of the library 816 as the media content of a media-based call alert. The URL identifier assigned to the specified media content item is communicated by the calling-subscriber terminal device 3 to the called-subscriber terminal device 5 as part of a “remote-URL” type Media Request command prior to establishing the voice call between the calling-subscriber terminal device 3 and the called-subscriber terminal device 5. The called-subscriber terminal device 5 utilizes the media content referenced by the URL identifier of the “remote-URL” type request to access the corresponding media content item stored remotely in the library 816, and then plays the corresponding media content item on the called-subscriber terminal device 5 prior to (or concurrent with) the establishment of the voice call between the subscriber terminal devices as described below in more detail.

The calling-subscriber terminal device 3 can store locally one or more media content items. The calling subscriber can specify one of the locally stored media content items as the media content of a media-based call alert. The specified media content is communicated by the calling-subscriber terminal device 3 to the called-subscriber terminal device 5 as part of a “Peer-to-Peer” type Media Request command prior to establishing the voice call between the calling-subscriber terminal device 3 and the called-subscriber terminal device 5. The called-subscriber terminal device 5 plays the media content communicated by the “P-P” type request prior to (or concurrent with) the establishment of the voice call between the subscriber terminal devices as described below in more detail.

The Subscriber Terminal (ST) Set Status function 801 is executed on both the calling-subscriber terminal device 3 and the called-subscriber terminal device 5 during the media-based call alert communication process. It is responsible for updating the presence information (e.g., “opt-in”/“opt-out” status) of the particular subscriber that is executing the application 11 on the respective subscriber terminal device as well as the device data of the respective subscriber terminal device. The updated presence information and device data is carried as part of a “Set Status” command communicated from the respective subscriber terminal device to the query server 9. The Query Server (QS) Set Status function 803 on the query server 9 receives and parses the “Set Status” command, collects the updated presence information and device data from the received “Set Status” command, and updates the presence information and device data stored in the database 15 for the particular subscriber in accordance with the received updated presence information, if needed.

Preferably, the database 15 is initialized such that the presence information for the particular subscriber has a system-wide default value (e.g., “opt-out” status), and the initial execution of the application 11 by the particular subscriber invokes the ST Set Status function 801 to set the presence information for the particular subscriber in the database 15 to a subscriber-modifiable default state (e.g., “opt-in”). The presence information can then be updated by subscriber interaction with a graphical user interface presented to the particular subscriber, which again invokes the ST Set Status function 801 to update the presence information for the particular subscriber in the database 15.

The ST Get Status function 805 may be executed on both the calling-subscriber terminal device 3 and the called-subscriber terminal device 5 during the media-based call alert communication process. The ST Get Status function 805 cooperates with QS Get Status Function 807 on the query server 9 to synchronize the buddy list and associated permissions data and status data of the particular subscriber that is executing the application 11 on the respective subscriber terminal device. The updated buddy list and associated permission data is carried as part of a “Get Status” command communicated from the respective subscriber terminal device to the query server 9, which updates the database 15 accordingly. Updates to the status data associated with the buddy list are carried as part of an “Update Status” command communicated from the query server 9 to the respective subscriber terminal device, which updates the status data stored on the respective subscriber terminal device as needed. In the preferred embodiment, the ST Get Status function 805 is carried out by both the calling-subscriber terminal device and the called-subscriber terminal device on a predefined, periodic basis (e.g., every 300 seconds) so as to maintain the query server 9 with up-to-date permissions and status data for subscribers of the service. The period between the ST Get Status function calls can be configurable on each subscriber terminal device and/or by a parameter setting on the query server 9.

In alternate embodiments, presence information, buddy lists, permission data, device data or parts thereof can be maintained in the central registry (or possibly in a distributed registry) and updated by communication between the subscriber terminals 3, 5 and the registry via a communication interface therebetween. In such embodiments, the presence information, buddy lists, permission data, device data or parts thereof maintained in the registry can be communicated to the query server 9 via a communication interface therebetween.

A calling subscriber initiates the communication of a media-based call alert to a called subscriber, which is typically accomplished by user interaction with a graphical user interface displayed by the application 11 on the display device 61 of the calling-subscriber terminal device 3. As described above, the media content of the media-based call alert can selected from a common library of media content items (i.e., a “Local-ID”-type media-based call alert), from a remote library of media content items (i.e., a “Remote-ID”-type media-based call alert, or from a locally stored media content item (i.e., a “Peer-to-Peer”-type media-based call alert).

In response thereto, the Originating Party (OP) Initiate Media Call function 809 is executed on the calling-subscriber terminal device 3. It communicates an “Initiate Media Call” command to the query server 9. The “Initiate Media Call” command identifies the called subscriber typically by the user name (e.g., screen name or email address assigned to the called subscriber) and can also identify the content type of the media-based call alert (e.g., a commercial audio alert-type, a commercial video alert-type, a recorded audio alert-type, a recorded video alert type, etc.). In response thereto, the QS Initiate Media Call function 811 executing on the query server 9 accesses the database 15 to retrieve the presence information and device data for the called subscriber. The query server 9 can also retrieve the permissions associated with the buddy list of the called subscriber. In distributed architectures, the query server 9 may be required to communicate with a central registry (or possibly a distributed registry) in order to retrieve the appropriate presence information, buddy list, permissions data, device data or parts thereof for the called subscriber.

The query server 9 then checks whether the presence information and/or the device data and/or the permissions data of the called subscriber indicates that the media-based call alert communication originating from the calling subscriber should be “allowed” or “blocked.” The serviceability status (i.e., “authorized” or “not-authorized”) for the media-based call alert communication is returned to the calling-subscriber terminal device 3. Such serviceability status is based upon the presence information and/or permission data and/or device data for the called subscriber (e.g., the serviceability status is “authorized” in the event that the presence information for the called-subscriber indicates the “opt-in” state, the permissions data for the called subscriber indicate that media-based call alert communication originating from the calling subscriber should be “allowed”, and the device data for the called subscriber indicates that the appropriate application is installed and activated on the called subscriber terminal device and thus communication of the media-based called alert communication should be possible; or the serviceability status is “not-authorized” in the event that the presence information for the called-subscriber indicates the “opt-out” state or the permissions data for the called subscriber indicate that media-based call alert communication originating from the calling subscriber should be “blocked”, or the device data for the called subscriber indicates that the appropriate application is not installed or not activated on the called subscriber terminal device and thus communication of the media-based called alert communication is not possible). As described herein, the permissions data for the called subscriber can pertain to all media-based call alerts originating from the calling subscriber; alternatively, the permissions data for the called subscriber can pertain to one or more particular content-types of the media-based call alerts originating from the calling subscriber as described herein. In the alternative case, the permissions data corresponding to the particular content-type of the media-based call alert specified by the calling subscriber is used to determine the serviceability status of the called subscriber.

The OP Initiate Media Call function 809 determines if the returned status indicates that the called subscriber is “serviceable”, and if so initiates the OP Transfer Media function 813 as described below. The transition from the OP Initiate Media Call function 809 to the OP Transfer Media function 813 is designated by arrow 812. If the returned status indicates that the called subscriber is “not serviceable”, the OP Initiate Media Call function 809 can display such status to the calling subscriber on the display device 61 and/or possibly raise other alerts on the calling-subscriber terminal device 3, and then end the processing of the media-based call alert communication to the called subscriber. It is also possible for the presence information and/or the device data and/or the permissions data of the called subscriber to be returned from the query server 9 to the calling-subscriber terminal device 3 and used by the called-subscriber terminal device 3 to determine the serviceability status of the calling subscriber in a manner similar that described above for the query server 9.

Note that in response to the “Initiate Media Call” command, the QS Initiate Media Call function 811 may initiate an Accounting Function (not shown) that performs the following tasks: (i) creating a transaction/call record for reporting purposes, and/or (ii) validating that the calling subscriber and the called subscriber can be correctly billed for the media-based call alert communication of the present invention, if necessary.

The OP Transfer Media function 813 is executed on the calling-subscriber terminal device 3. As shown in FIG. 6B, the function 813 communicates a “Media Request” command to the called-subscriber terminal device 5. The “Media Request” command preferably can have one of three types corresponding to the different call alert types as described above (e.g., a “local-ID” type, a “remote-URL” type, and a “Peer-to-Peer” type).

The “local-ID” type Media Request command includes one or more identifiers that refer to one or more media content item stored locally in the library of media content items of the called-subscriber terminal 5 as described above.

The “remote-URL” type Media Request command includes one or more URL identifiers that refer to one or more media content item stored in the library 816 as described above.

The “Peer-to-Peer” type Media Request includes the following: (i) a file name and possibly corresponding file type of one or more media files that make up the media-based call alert, (ii) the size of these media file(s), and (iii) digital rights management (DRM) information for the media file(s). Such DRM information preferably includes:
permissions/entitlements that designate consumption rights or restrictions imposed on these media file(s), and
URLs (or IP addresses) for one or more servers for obtaining keys for decrypting the media file(s) that make up the media-based call alert and for obtaining the requisite permissions/entitlements.
   The permissions/entitlements that can be used to designate consumption rights or restrictions imposed on the media file(s) of the media-based alert are described above in detail with respect to the “Transfer Media Request” command of FIG. 2.

Prior to issuing the “Media Request” command, the OP Media Transfer function 813 can communicate with the called-subscriber terminal device 5 to invoke a polling process executed on the called-subscriber terminal 5. This polling process will search media file(s) stored locally on the called-subscriber terminal 5 and determine if any of the locally-stored media files correspond to the media content selected by the calling subscriber for the media-based call alert. Status information pertaining to the results of the polling process is then communicated back from the called-subscriber terminal 5 to the calling-subscriber terminal 3. Such status information can be used to dictate the type of the “Media Request” command. For example, in the case that the status information indicates the media content for the media-based call alert is stored locally on the called-subscriber terminal device 5, a “local-ID” type Media Request command can be communicated to the called-subscriber terminal device 5. However, in the case that the status information indicates the media content for the media-based call alert is not stored locally on the called-subscriber terminal device 5, a “remote-URL”-type or “Peer-to-Peer”-type Media Request command can be communicated to the called-subscriber terminal device 5. It is contemplated that the called subscriber can store media content received from previous media-based call alerts from the calling subscriber (or received from other sources, such as a media-based call alert previously generated by the called subscriber or a media-based call alert received from another subscriber). The polling process described above can be used to initiate a “local-ID” type Media Request command (instead of a “remote-URL”-type or “Peer-to-Peer”-type Media Request command) for those instances where the media content for the media-based call alert is stored locally on the called-subscriber terminal 5, which advantageously reduces the amount of information communicated to the called-subscriber terminal 5 and thus reduces the required bandwidth and latency for communicating the media-based call alert to the called-subscriber terminal 5.

In the event that such polling process determines that called-subscriber terminal 5 locally stores one or more media files corresponding to the media content selected by the calling subscriber for the media-based call alert, the query server 9 can be controlled (either by the called-subscriber terminal or the calling-subscriber terminal) to source reference data for one or more media content items that do not exist on the calling-subscriber terminal. The reference data can be derived from content information maintained by the query server itself or from third-party sources. The identification of the referenced media content items is preferably based on behavioral targeting rules (e.g., rules that identify those media content items that are favored by users who have purchased the identified content items or multiple identified content items). The references to such media content items can be communicated to the calling-subscriber device 3 and presented to the calling subscriber as an alternative content media item for use as the media-based called alert to the called subscriber.

The RP Transfer Media function 815 executing on the called-subscriber terminal device 5 processes the “Media Request” command as shown in FIG. 6B.

### “Local-ID”-Type Media Request Processing

For the “local-ID” type Media Request command (steps 855, 857, 867, 877), the RP Transfer Media function 815 utilizes the identifier(s) of the “local-ID” type Media Request command to verify that the corresponding media content item(s) is/are stored locally in its library of media content items (step 855), and then generates and sends a “Media Received” command to the calling-subscriber terminal device 3 (step 867) and waits for acknowledgement of the “Media Received” command from the calling-subscriber terminal device 3 (step 877).

Upon receipt of this “Media Received” command, the OP Transfer Media function 813 of the calling-party subscriber terminal device 3 initiates communication of a corresponding acknowledge command directed back to the called-subscriber terminal device 5 (steps 873, 875) and then initiates the OP Voice Call Setup function 821.

Upon receiving the acknowledge command that is returned from the calling-subscriber terminal device 3 indicating receipt of the “Media Received” command, the RP Transfer Media function 815 initiates the RP Voice Call Setup function 123.

The OP Voice Call Setup function 821 cooperates with the ST Voice Call Processing logic 60 executing on the calling-subscriber terminal device 3 in order to provision a voice call to the called-subscriber terminal device 5 using available network resources as described above with respect to the first embodiment of FIG. 2. The voice call can be accomplished over a cellular network, a data packet network (e.g., VOIP call over the Internet), or other suitable communication network.

The RP Voice Call Setup function 823 cooperates with the ST Voice Call Processing logic 60 executing on the called-subscriber terminal device 5 such that called-subscriber terminal device 5 is placed in “incoming call wait mode” whereby the processing of all incoming voice calls is diverted to the RP Voice Call Setup function 823. More particularly, the ST Voice Call Processing Logic 60 passes caller identifier information for each incoming call to the RP Voice Call Setup Function 823. The RP Voice Call Setup function 823 validates this caller identifier information against caller identifier information that it has stored for the calling subscriber in a manner similar to the operations shown in FIG. 5. If the caller identifier information for the incoming call does not match the stored caller identifier information, the RP Voice Call Setup function 823 releases the call such that the call is handled by the ST Voice Call Processing Logic 60. If the caller identifier information for the incoming call does match the stored caller identifier information, the RP Voice Call Setup function 823 passes the media file(s) identified by the local identifier(s) of the “Local-ID” type Media Request processed in steps 853, 855, 857 to the appropriate media player, which is typically stored as part of the core applications and operating system 57 of the called-subscriber terminal device 3. In this manner, the media player executing on the called-subscriber terminal device 5 plays the locally-stored media file(s) that makes up the “local-ID”-type media-based call alert as initiated by the calling subscriber.

The locally-stored media file(s) of the “Local-ID” type Media Request can be protected by DRM information. In this case, the operations of step 865 can be performed to retrieve media file entitlement data related thereto as described below. When the traditional incoming call processing is bypassed (e.g., the caller identifier information for the incoming call matches the stored caller identifier information), the RP Voice Call Setup function 823 passes the locally-stored DRM protected media file(s) (verified in block 857) and the retrieved media file entitlement data related thereto (block 865) to the appropriate DRM client on the called subscriber terminal device 5. The DRM client utilizes the decryption key(s) of the media file entitlement data to decrypt the media file(s) and passes the media file(s) in decrypted form to the appropriate media player. The DRM client cooperates with the media player to conform to the consumption restrictions (e.g., execute and not save) imposed on the media file(s) as dictated by the DRM license data associated therewith. In this manner, the media player executing on the called-subscriber terminal device 5 plays the locally-stored media file(s) that makes up the “local-ID”-type media-based call alert as initiated by the calling subscriber. The playing of the locally-stored media file(s) is an announcement of the incoming voice call initiated by the calling subscriber.

### “Remote-URL”-Type Media Request Processing

For the “remote-URL” type Media Request command (steps 859, 861, 865, 867, 877), the RP Transfer Media function 815 utilizes the URL identifier(s) of the “remote-URL” type Media Request command to retrieve from the library 816 the media content files(s) identified by such URL identifier(s) (step 861). In the illustrated embodiment, this is accomplished by communicating a “Get Media Request” command to the library 816 of the query server 9, which returns the requested media content file(s) by a “Send Media” command. The returned media content file(s) is(are) protected by DRM information. In step 865, the RP Transfer Media function 815 communicates a “Get Media Entitlement” command to the query server 9. The QS Media File Entitlement Processing function 819 executing on the query server 9 receives the “Get Media Entitlement” command and obtains the necessary decryption key(s) and DRM license data (collectively, media file entitlement data) associated with the returned media file(s) of the “remote-URL” type Media Request command processed in step 861. Such media file entitlement data can be stored locally on the query server 9 or obtained from another server operably coupled thereto. Upon acquisition of the necessary media file entitlement data, the QS Media File Entitlement Processing function 819 forwards the media file entitlement data to the called-subscriber terminal device 5 as part of a “Send Media Entitlement” command communicated thereto. Alternatively, the Media File Entitlement Processing function 819 can be carried out as part of the called-subscriber terminal device 5 to interact with the appropriate servers to acquire the necessary media file entitlement data for the remotely located media file(s) that make up the “Remote-URL”-type media-based call alert.

The RP Transfer Media function 815 then generates and sends a “Media Received” command to the calling-subscriber terminal device 3 (step 867) and waits for acknowledgement of the “Media Received” command from the calling-subscriber terminal device 3 (step 877).

Upon receipt of this “Media Received” command, the OP Transfer Media function 813 of the calling-party subscriber terminal device 3 initiates communication of a corresponding acknowledge command directed back to the called-subscriber terminal device 5 (steps 873, 875) and then initiates the OP Voice Call Setup function 821.

Upon receiving the acknowledge signal that is returned from the calling-subscriber terminal device 3 indicating receipt of the “Media Received” command, the RP Transfer Media function 815 initiates the RP Voice Call Setup function 123.

The OP Voice Call Setup function 821 cooperates with the ST Voice Call Processing logic 60 executing on the calling-subscriber terminal device 3 in order to provision a voice call to the called-subscriber terminal device 5 using available network resources as described above with respect to the first embodiment of FIG. 2. The voice call can be accomplished over a cellular network, a data packet network (e.g., VOIP call over the Internet), or other suitable communication network.

The RP Voice Call Setup function 823 cooperates with the ST Voice Call Processing logic 60 executing on the called-subscriber terminal device 5 such that called-subscriber terminal device 5 is placed in “incoming call wait mode” whereby the processing of all incoming voice calls is diverted to the RP Voice Call Setup function 823. When the traditional incoming call processing is bypassed (e.g., the caller identifier information for the incoming call matches the stored caller identifier information), the RP Voice Call Setup function 823 passes the retrieved DRM protected media file(s) (step 861) and the retrieved media file entitlement data related thereto (block 865) to the appropriate DRM client on the called-subscriber terminal device 5. The DRM client utilizes the decryption key(s) of the media file entitlement data to decrypt the media file(s) and passes the media file(s) in decrypted form to the appropriate media player. The DRM client cooperates with the media player to conform to the consumption restrictions (e.g., execute and not save) imposed on the media file(s) as dictated by the DRM license data associated therewith. In this manner, the media player executing on the called-subscriber terminal device 5 plays the remotely-stored media file(s) that makes up the “Remote-URL”-type media-based call alert as initiated by the calling subscriber. The playing of the media file(s) is an announcement of the incoming voice call initiated by the calling subscriber.

### “Peer-to-Peer”-Type Media Request Processing

For “Peer-to-Peer”-type Media Request commands (steps 859, 863, 865, 867, 877), the RP Transfer Media Package function 815 performs peer-to-peer media transfer operations similar to those described above in FIG. 2. These operations include the processing the “Media Request” command to determine if the media file(s) identified therein can be received and processed by the called-subscriber terminal device 5, and returning the “Ack P-P Transfer Media Request” command to the calling-subscriber terminal device 3. The “Ack P-P Transfer Media Request” command preferably includes the following: (i) a preferred format for the media file(s), (ii) available memory on the called-subscriber terminal device 5, and (iii) acknowledgement of ability to comply with the DRM restrictions imposed on the media file(s).

Upon receipt of the “Ack P-P Transfer Media Request” command, the OP Transfer Media function 813 executing on the calling-subscriber terminal device 3 validates the information supplied therein for compliance. Such validation preferably confirms that the called-subscriber terminal device 5 can accept and consume the media file(s) that make up the media-based call alert as intended and in the format provided by the calling-subscriber terminal device 5. If such validation is successful, the OP Transfer Media function 813 initiates communication of the “Send Media” command to the called-subscriber terminal device 5. The “Send Media” command preferably includes the following: (i) the media file(s) for media-based call alert in encrypted form, (ii) meta-data relevant to these media file(s) (e.g., name, creator(s), performer(s) etc.), (iii) DRM information for the media file(s) as described above, and, if applicable, (iv) additional media and/or information combined with the media-based call alert during the transfer process. Upon receipt of the “Send Media” command, the RP Transfer Media Package function 815 initiates communication of a corresponding acknowledge command that is returned back to the calling-subscriber terminal device 3. Upon receipt of this acknowledge command, the OP Transfer Media Package function 813 is placed into a wait state pending receipt of the “Media Received” command to be issued by the RP Transfer Media Package function 815 as described below.

In the event that the validation of the “Ack P-P Transfer Media Request” command fails, the OP Transfer Media function 813 can display such status to the calling subscriber on the display device 61 and/or possibly raise other alerts on the calling-subscriber terminal device 3, and then end the processing of the media-based call alert communication to the called subscriber.

If the processing of “Ack P-P Transfer Media Request” command indicates that the called-subscriber terminal device 3 requires the media content of the “Peer-to-Peer” type media-based call alert in a different format, the OP Transfer Media function 813 can initiate the “Send Media To” command to the query server 9. The “Send Media To” command preferably includes the following information: (i) the address of the called-subscriber terminal device 5, (ii) optionally, details about the media file(s) that make up the media-based call alert, (iii) optionally, the media file(s), (iii) the required format for the media file(s) as requested by the called subscriber in the “Ack P-P Transfer Media Request” command, (iv) DRM information for the media file(s) as described above, and, if applicable, (v) a timing instruction that determines when, if not immediately, the media-based call alert is to be transferred. Upon successful receipt of the “Send Media To” command, QS Transfer Media function 817 executing on the query server 9 sends a corresponding acknowledge command back to the calling-subscriber terminal device 3. Upon receipt of this acknowledge command, the OP Transfer Media function 813 is placed into a wait state pending receipt of the “Media Received” command to be issued by the RP Transfer Media function 815 as described below.

The QS Transfer Media function 817 operates to either (i) transcode the media file(s) received from the calling-subscriber terminal device 3 into the suitable format as identified by the calling-subscriber device 3 in the “Send Media To” command or (ii) acquire a new copy of the media file(s) in the suitable format. The new copy can be acquired from a media store maintained by the query server 9 or a media store operably coupled thereto. Upon generating (or acquiring) the media file(s) in the suitable format, the QS Transfer Media function 817 initiates the communication of the “Send Media” command (which is described above in detail) to the called subscriber terminal device 5. Upon receipt of the “Send Media” command, the RP Transfer Media function 815 initiates communication of a corresponding acknowledge command that is returned back to the query server 9, thereby indicating successful delivery of the “Send Media” command to the called-subscriber terminal device 3. The ends the peer-to-peer media transfer operations of step 863.

In step 865, the RP Transfer Media function 815 communicates a “Get Media Entitlement” command to the query server 9. The QS Media File Entitlement Processing function 819 executing on the query server 9 receives the “Get Media Entitlement” command and obtains the necessary decryption key(s) and DRM license data (collectively, media file entitlement data) associated with the media file(s) transferred in step 863. Such media file entitlement data can be stored locally on the query server 9 or obtained from another server operably coupled thereto. Upon acquisition of the necessary media file entitlement data, the QS Media File Entitlement Processing function 819 forwards the media file entitlement data to the called-subscriber terminal device 5 as part of a “Send Media Entitlement” command communicated thereto. Alternatively, the Media File Entitlement Processing function 819 can be carried out as part of the called-subscriber terminal device 5 to interact with the appropriate servers to acquire the necessary media file entitlement data for the remotely located media file(s) that make up the “Peer-to-peer”-type media-based call alert.

The RP Transfer Media function 815 then generates and sends a “Media Received” command to the calling-subscriber terminal device 3 (step 867) and waits for acknowledgement of the “Media Received” command from the calling-subscriber terminal device 3 (step 877).

Upon receipt of this “Media Received” command, the OP Transfer Media function 813 of the calling-party subscriber terminal device 3 initiates communication of a corresponding acknowledge command that is returned back to the called-subscriber terminal device 5 (steps 873, 875) and then initiates the OP Voice Call Setup function 821.

Upon receiving the acknowledge signal that is returned from the calling-subscriber terminal device 3 indicating receipt of the “Media Received” command, the RP Transfer Media function 815 initiates the RP Voice Call Setup function 123.

The OP Voice Call Setup function 821 cooperates with the ST Voice Call Processing logic 60 executing on the calling-subscriber terminal device 3 in order to provision a voice call to the called-subscriber terminal device 5 using available network resources as described above with respect to the first embodiment of FIG. 2. The voice call can be accomplished over a cellular network, a data packet network (e.g., VOIP call over the Internet), or other suitable communication network.

The RP Voice Call Setup function 823 cooperates with the ST Voice Call Processing logic 60 executing on the called-subscriber terminal device 5 such that called-subscriber terminal device 5 is placed in “incoming call wait mode” whereby the processing of all incoming voice calls is diverted to the RP Voice Call Setup function 823. When the traditional incoming call processing is bypassed (e.g., the caller identifier information for the incoming call matches the stored caller identifier information), the RP Voice Call Setup function 823 passes the transferred DRM protected media file(s) (step 863) and the retrieved media file entitlement data related thereto (block 865) to the appropriate DRM client on the called subscriber terminal 5. The DRM client utilizes the decryption key(s) of the media file entitlement data to decrypt the media file(s) and passes the media file(s) in decrypted form to the appropriate media player. The DRM client cooperates with the media player to conform to the consumption restrictions (e.g., execute and not save) imposed on the media file(s) as dictated by the DRM license data associated therewith. In this manner, the media player executing on the called-subscriber terminal device 5 plays the peer-to-peer transferred media file(s) that makes up the “Peer-to-Peer”-type media-based call alert as initiated by the calling subscriber. The playing of the media file(s) is an announcement of the incoming voice call initiated by the calling subscriber.

The communication system of the present invention as described above can operate to distribute commercial pre-recorded audio and video media as part of a media-based call alert. Such distribution can occur across national borders and even internationally. The rights to commercial pre-recorded audio and video media include:
i) mechanical rights held by the copyright owner of the composition underlying the recorded media and/or by a regional mechanical rights agency (e.g., MCPS and NMPA);
ii) performance rights typically held by Performing Rights Societies such as ASCAP, BMI, MCPS, JASRAC, SOCAN, BUMA/STEMRA and APRA-AMCOS; and
iii) master recording rights held by the copyright owner of the recorded media.
   Licenses to these rights are typically limited to some but not all territories/countries. The communication system of the present invention is able to control the distribution and use of commercial pre-recorded audio and video media as part of a media-based call alert conforms to the territorial restrictions of the licensed rights associated with the media content. Furthermore, in the case that the Sender and the Recipient are in different territories at the time of the transmission of a media-based call alert, the communication system of the present invention is able to determine the relative rights associated with the media content, as embodied within the media-based call alert, and respond to notify system and the Sender and/or Recipient about the restriction, and/or modify (e.g., offer the Sender options either to offer alternative media content for the announcement, or to buy and gift the media content to the Recipient), restricted or prohibit the transfer of the media content accordingly.

In a preferred embodiment, the functionality of the query server 9 is extended to maintain a content management database (CMD) of information that identifies the licensed rights and the territories associated therewith (e.g., allowed territories and/or restricted territories) for commercial media content items or groups thereof. The content management database is accessed to ensure conformance to territorial restrictions pertaining to the distribution of commercial media as part of the media-based call alert processing as described herein.

In an illustrative embodiment shown in FIG. 6C, the content management database is accessed as part of the query server's QS Media File Entitlement Processing function 819 of FIG. 6A to ensure conformance to territorial restrictions pertaining to the distribution of commercial media as part of a media-based call alert as described herein. The operations begin by receiving a “Get Media Entitlement” command (step 8003) communicated from the called-subscriber terminal device 5 to the query server 9 (step 8001) as described herein. The “Get Media Entitlement” command includes data that identifies the media file(s) of the media-based call alert. For “Local-ID”-type media-based call alerts, such data preferably includes one or more identifiers assigned to one or more media content items stored in the common libraries on the terminals devices 3, 5 as described above. For “Remote-URL”-type media-based call alerts, such data preferably includes one or more URL identifiers that refer to one or more media content item stored in the library 816 as described above. For “Peer-to-Peer”-type media-based call alerts, such data preferably includes the following: (i) a file name and possibly corresponding file type of one or more media files that make up the media-based call alert, and possibly (ii) digital rights management (DRM) information for the media file(s).

In step 8005, the QS Media File Entitlement Processing function 819 retrieves (or obtains) the necessary decryption key(s) and DRM license data (collectively media file entitlement data) associated with the media file(s) identified by the “Get Media Entitlement” command. Such DRM license data can be stored locally on the query server 9 or obtained from another server operably coupled thereto.

In step 8007, the QS Media File Entitlement Processing function 819 accesses the CMD of the query server 9 to retrieve data that identifies zero or more excluded territories for the media file(s) identified by the “Get Media Entitlement” command.

Upon acquisition of the media file entitlement data (step 8005) and the excluded territory data (step 8007), the QS Media File Entitlement Processing function 819 forwards the media file entitlement data and the excluded territory data to the called-subscriber terminal device 5 as part of a “Send Media Entitlement” command communicated thereto (steps 8009 and 8011).

The RP Transfer Media Package function 815 receives the “Send Media Entitlement” command (step 8013) and carries out the operations of steps 867 and 877 and the RP Voice Call Setup function 123 to play the media content of the media-based call alert as specified by the calling subscriber on the called-subscriber terminal device 5 in conjunction with an incoming voice call communicated from the calling-subscriber terminal device 3 to the called-subscriber terminal device 5 as described above. In step 8015, concurrent or subsequent to such processing (for example, during the playing of the media content of the media-based call alert), RP Interactive User Interface Processing function 827 of the application 11 executing on the called-subscriber terminal device 5 identifies the territory of the terminal device 5. The territory of the terminal device 5 can be determined by analyzing a variety of information related thereto, such as product registration information, the location of the wireless network, the IP address of the terminal device 5, and LBS information.

In step 8017, the RP Interactive User Interface Processing function 827 determines whether the territory of the terminal device 5 (step 8015) corresponds to any of the excluded territories identified by the content of the received “Send Media Entitlement” command (step 8013).

In the event that the determination of step 8017 is false (the territory of the terminal device 5 does not correspond to any of the excluded territories), the operations continue to generate and send a “Gift Available” command to the calling-subscriber terminal device 3 (block 8023) and present a [Buy] option as part of the user interface presented to the called subscriber on the display screen of the called-subscriber terminal device 5 (block 8025). The [Buy] option is associated with the media file(s) of the media-based call alert. In the event that the called subscriber selects the [Buy] option, the RP Interactive User Interface Processing function 827 generates a sends a “Media Buy” command to the query server 9 (step 8027). The “Media Buy” command includes i) data that identifies the media file(s) of the media-based call alert/{Buy} option, and possibly ii) digital rights management (DRM) information for the media file(s).

The QS Media File Entitlement Processing function 819 of the query server 9 receives the “Media Buy” command communicated from the called-subscriber terminal device 5 (step 8029) and then retrieves or obtains DRM license data for the media file(s) identified by the received “Media Buy” command, such DRM license data in conformance with the licensed rights of such media file(s) (step 8031). For example, it is contemplated that the license rights for one or more media files allows for user playing and saving such files when purchased. In this case, the DRM license data returned for such content allows for playing and saving such media files. The DRM license data can be stored locally on the query server 9 or obtained from another server operably coupled thereto.

In step 8033, the QS Media File Entitlement Processing function 819 forwards the DRM license data obtained in step 8031 to the called-subscriber terminal device 5 as part of an “Update Media Entitlement” command communicated thereto. The function 811 may initiate an Accounting Function (not shown) that performs the following tasks: (i) creating a transaction record for reporting purposes and billing purposes, if necessary, and/or (ii) validating that the called subscriber can be correctly billed for the media content of the media-based call alert communication, if necessary.

In step 8035, the RP Transfer Media Package function 815 receives the “Update Media Entitlement” command and cooperates with the DRM client of the called-subscriber terminal 5 to update the consumption restrictions imposed on the media file(s) as dictated by the DRM license data received as part of the “Update Media Entitlement” command. In this manner, the process flow enables the called subscriber to “buy” and use media content in conformance with the license rights associated therewith.

The receipt of the “Gift Available” command at the calling-subscriber terminal device 3 (block 8035) triggers the OP Interactive User Interface Processing function 825 to present a [Gift] option as part of the user interface presented to the calling subscriber on the display screen of the calling-subscriber terminal device 3 (block 8025). The [Gift] option is associated with the media file(s) of the media-based call alert. In the event that the calling subscriber selects the [Gift] option, the OP Interactive User Interface Processing function 825 generates a sends a “Media Gift” command to the query server 9 (step 8041). The “Media Gift” command includes i) data that identifies the media file(s) of the media-based call alert/{Gift} option, and possibly ii) digital rights management (DRM) information for the media file(s).

The QS Media File Entitlement Processing function 819 of the query server 9 receives the “Media Gift” command communicated from the calling-subscriber terminal device 3 (step 8043) and then retrieves or obtains DRM license data for the media file(s) identified by the received “Media Gift” command in a manner similar to that described above for the {Buy} option. The operations then continue to step 8033 whereby the QS Media File Entitlement Processing function 819 forwards the DRM license data obtained in step 8031 to the called-subscriber terminal device 5 as part of an “Update Media Entitlement” command communicated thereto. The function 811 may initiate an Accounting Function (not shown) that performs the following tasks: (i) creating a transaction record for reporting purposes and billing purposes, if necessary, and/or (ii) validating that the calling subscriber can be correctly billed for the “gifted” media content of the media-based call alert communication, if necessary.

In step 8035, the RP Transfer Media Package function 815 receives the “Update Media Entitlement” command and cooperates with the DRM client of the called-subscriber terminal 5 to update the consumption restrictions imposed on the media file(s) as dictated by the DRM license data received as part of the “Update Media Entitlement” command. In this manner, the process flow enables the calling subscriber to “gift” media content to the called subscriber for use in conformance with the license rights associated therewith.

In the event that the determination of step 8017 is true (the territory of the terminal device 5 does correspond to at least one of the excluded territories), the operations continue to generate and send a “Gift Unavailable” command to the calling-subscriber terminal device 3 (block 8019) and present a “Buy Unavailable” notification as part of the user interface presented to the called subscriber on the display screen of the called-subscriber terminal device 5 (block 8021). The receipt of the “Gift Unavailable” command at the calling-subscriber terminal device 3 (step 8037) disables the ability of the calling subscriber to “gift” the media content to the called subscriber as described above and thus ensures that the distribution of the media content conforms to the license rights associates therewith. Similarly, the logic of decision step 8017 disables the ability of the called subscriber to “buy” the media content and thus ensures that the distribution of the media content conforms to the license rights associates therewith.

In a preferred embodiment, the functionality of the query server 9 can be adapted to i) communicate the media-based call alert command to a secondary called-party device and/or ii) to enable the called-party to access the media content of the media-based call alert command for those instances where the called-party is not serviceable at the time of call initiation by the calling-party. FIG. 6D illustrates exemplary operations that carry out these functions as part of the QS Initiate Media Call function 811 of FIG. 6A. The operations begin by receiving the “Initiate Media Call” command from the calling-subscriber terminal device 3 (step 8051) and the determining whether the called subscriber is serviceable based upon the presence information and permissions data associated therewith as described above. In the event that the called subscriber is serviceable, the serviceability state of “available” is returned to the calling subscriber terminal (step 8055) and the operation of function 811 ends. In the event that the called subscriber is not-serviceable, the operations continue to step 8057 to identify the ANI of a secondary communication device for the called subscriber (or other data for connecting to a secondary communication device for the called subscriber). This data can be stored in a hierarchical list associated with the called subscriber as part of the database 15 of the query server. In step 8059, the serviceability of the called subscriber at the secondary communication device is checked. The operations of steps 8057 and 8059 can be performed in a recursive manner for multiple devices in the hierarchical list. In the event that the called subscriber is serviceable at the second communication device, the serviceability state of “available” along with the ANI of the secondary communication device (or the other data for connected to the secondary communication device) is returned to the calling subscriber terminal (step 8061) and the operation of function 811 ends. In the event that the called subscriber is not-serviceable at the second communication device, the operations of steps 8063 to 8067 are performed.

In step 8063, for “Peer-to-Peer”-type media-based alerts, the function 811 cooperates with the calling-subscriber terminal device 3 to obtain a copy of the media content of the media-based alert and saves such data. For “Remote-URL”-type media-based alerts, the function 811 cooperates with the calling-subscriber terminal device 3 to obtain a reference to the media content of the media-based alert and saves such data.

In step 8065, the function 811 returns the serviceability state of “not-available” to the calling-subscriber terminal device 3.

In step 8067, the function 811 sends a store-and-forward message (such as an SMS message, MMS message, email message, or a SIP message) to the called subscriber providing notification of the attempted call and instructions on how to access the media content save in step 8063 (or referenced by the data saved in step 8063). The stored media content can be made available to the called subscriber as part of a voice mailbox accessible to the called subscriber or other suitable mechanism.

The serviceability state returned to the called-subscriber terminal device 3 in steps 8055, 8061 and 8065 are used by the OP Initiate Media Call function 809 to selectively initiate a media-base call alert command based thereon as described above in detail. The ANI of the secondary communication device (or such data for connecting to the secondary communication device) is passed to the OP Voice Setup function 821 for setting up the connection to the secondary communication device of the called subscriber.

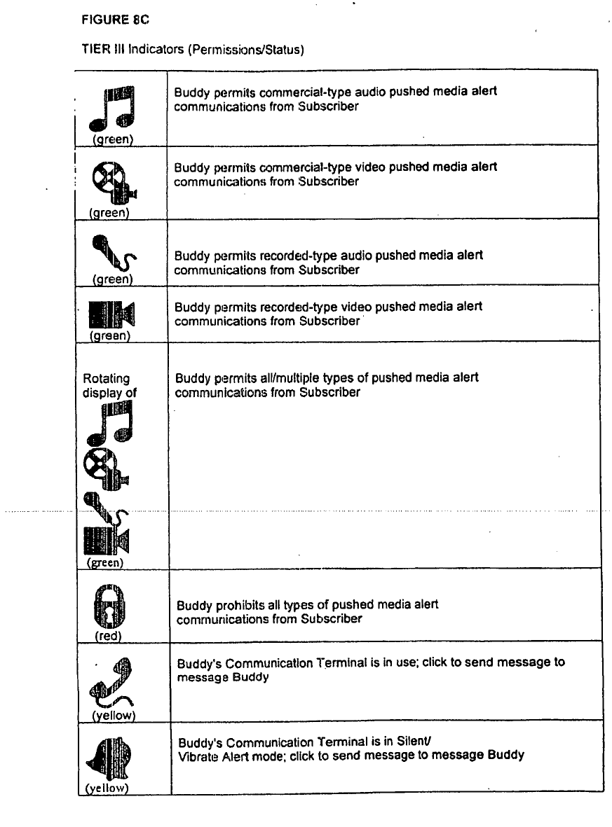

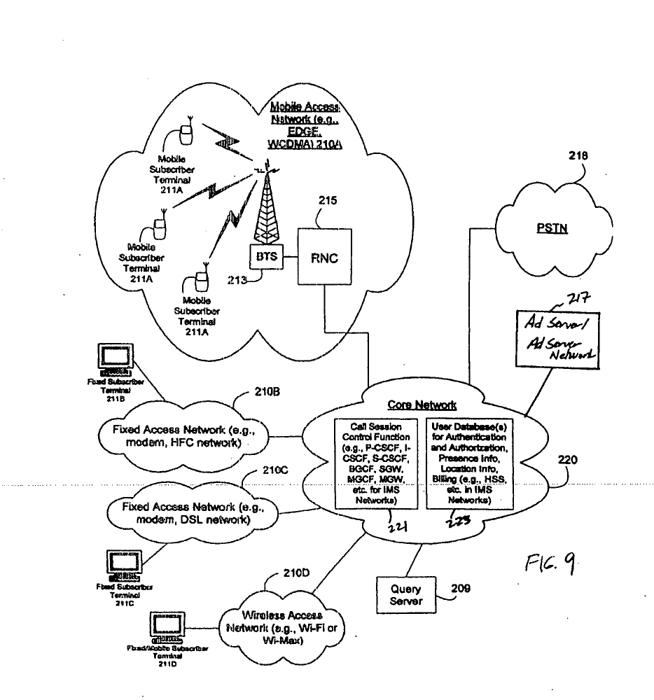

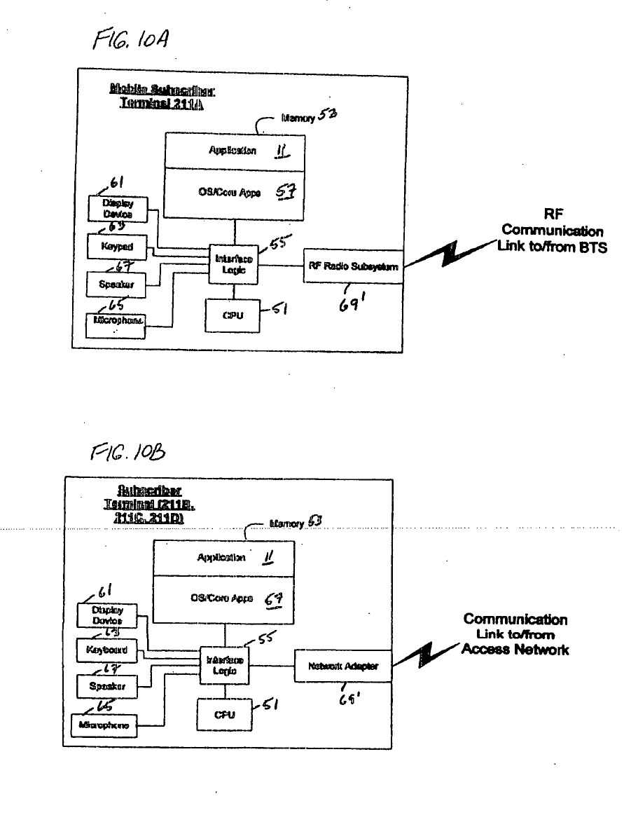

The application 11 executing on a subscriber terminal device maintains a buddy list graphical user interface, which allows the subscriber to see presence information associated with other known subscribers, to manage who can make media calls to the subscriber (e.g., selectively block or enable media-based call alert communications from other known subscribers), and to see whether or not the subscriber is blocked or enabled from making media-based call alert communications to other known subscribers. The buddy list can also provide an indication if other known users (who may or may not be subscribers) have a compatible device for receiving media-based call alert communications. In the preferred embodiment of the invention, the buddy list utilizes a set of multi-tiered icons to communicate device information, presence information and permissions and status information associated with subscribers (or non-subscribers) of the communication service of the present invention. FIG. 7 illustrates an example of such a buddy list interface. A list of buddies descends the middle column of the buddy list interface. One or more icons associated with a given buddy are presented to the left of the name of the given buddy. The icons are selected from a multi-tiered set of icons as shown in FIGS. 8A, 8B, and 8C. The icons of the first tier (FIG. 8A) depict device information (e.g., compatibility, configuration, call mode [silent], location) of the buddy's communication terminal. The user can click on these icons to initiate a compatibility check and/or an invitation to download and install the application 11 as noted in the table of FIG. 8A. The icons of the second tier (FIG. 8B) depict the presence information of the buddy's communication terminal as noted in the table of FIG. 8B. The icons of the third tier (FIG. 8C) depict permissions of the buddy for the subscriber as well as status information associated with the buddy's communication terminal as noted in the table of FIG. 8C. The buddy list interface of FIG. 7 can also include any of the features described above for the buddy list interface of FIG. 4.

The subscriber terminal device can also maintain a library of media content items that have been used as part of media-based call alerts initiated by the subscriber (i.e., in the calling subscriber role) and/or received by the subscriber (i.e., in the called subscriber role). The graphical user interface of the application 11 executing on the subscriber terminals can allow for navigation of this library as well as management thereof (e.g., deleting items, moving items, ordering items by date, order items by subscriber, etc.). It can also provide options for the subscriber to {Buy} particular media content (if not done so already). Selection of the {Buy} option preferably initiates processing similar to steps 8015-8035 as described above with respect to FIG. 6C to update the DRM licenses for the particular media content in conformance with the license rights associated therewith, when applicable).

Turning now to FIG. 9, there is shown a functional block diagram of an exemplary communication system that includes a variety of different access networks (mobile, fixed and wireless access networks). The communication system can operate within any access network, between users each connected to a different type of access networks, and from and to any users connected to any access network using any compatible device applicable to the access network in service. Mobile access networks are currently the most complex. Mobile subscriber terminals 211A communicate over wireless communication links to a mobile access network 210A. The mobile access network 210A includes a plurality of base stations 213 (one shown) that are operably coupled to radio network controllers 215 (one shown). The radio network controllers 215 are responsible for radio resource allocation to the mobile subscriber terminals 211A, and for frequency administration and handover between base stations 213. The radio network controller function may be physically located within a base station 213 itself.

Each base station 213 includes at least one antenna and a group of one or more radio transmitter-receiver pairs. Each transmitter-receiver pair operates on a pair of radio frequencies to create a communication channel: one frequency to transmit radio signals to a mobile subscriber terminal 211A and the other frequency to receive radio signals from the mobile subscriber terminal 211A. Each base station 213 defines a cell of the mobile access network 210A, which is a predetermined volume of space radially arranged around its antenna. In order to prevent the radio signals transmitted from one base station from interfering with radio signals transmitted from an adjacent base station, the transmitter frequencies for adjacent base stations are selected to be different so that there is sufficient frequency separation between adjacent transmitter frequencies. In order to reuse the same frequencies, the cellular telecommunication industry has developed a small but finite number of transmitter frequencies and allocation patterns that ensure that adjacent cell sites do not operate on the same frequency. When a mobile subscriber terminal 211A initiates a call connection, control signals transmitted from the local base station 213 cause the frequency agile transponder in the mobile subscriber terminal 211A to operate at the frequency of operation designated for that particular base station. As the mobile subscriber terminal 211A moves from one cell to another, the call connection is handed off to the successive base station and the frequency agile transponder in the mobile subscriber terminal 211A adjusts its frequency of operation to correspond to the frequency of operation of the base station 213 located in the cell in which the mobile subscriber terminal 211A is presently operational.

Numerous wireless technologies, such as EDGE technology, W-CDMA technology and WiMAX technology, can be used to implement the mobile access network 210A. EDGE technology provides enhanced GPRS services, which can be used for any packet switched applications such as an Internet connection. High-speed data applications such as video services and other multimedia services benefit from the increased data capacity provided by the enhanced GPRS services. W-CDMA technology employs wideband code division multiplexing technology to provide high speed packet switched data rates that is suitable for high-speed data applications such as video services and other multimedia services. WiMAX is a telecommunications technology aimed at providing wireless data over long distances in a variety of ways, from point-to-point links to full mobile cellular type access.

Fixed Subscriber terminals 211B communicate over communication links to a fixed access network 210B (e.g., a cable modem coupled to a hybrid fiber coax data network) as is well known. Fixed Subscriber terminals 211C communicate over communication links to another fixed access network 210C (e.g., a DSL modem coupled to a DSL access network) as is well known. Fixed or Mobile Subscriber terminals 211D communicate over communication links to a wireless access network 210D (e.g., a Wi-Fi or WiMax access network) as is well known. The mobile subscriber terminals 211A can be any of a number of communication devices including cellular handset devices, personal digital assistants, laptop computers, personal computers, networked kiosks, and the like. The subscriber terminals 211B, 211C, 211D can be any of a number of communication devices including personal computers, laptop computers, personal digital assistants, networked kiosks, VOIP phones, traditional phones connected to VOIP gateways, and the like.

The subscriber terminals 211A, 211B, 211C, 211D connect to the respective access networks using various methods based upon the standard Internet Protocol (IP). The access networks 210A, 210B, 210C, 210D interface to a core network 220 that provides the signaling functions that are necessary to establish voice over IP calls to and from the subscriber terminals. The core network 220 also preferably interfaces to the Public Switched Telephone Network 220 to allow for voice over IP calls to be transformed into a form suitable for communication over the PSTN.

The communication system of FIG. 5 supports peer-to-peer voice over IP call communications which employ push-type communication of a media-based announcement from a calling-subscriber terminal device to a called-subscriber terminal device in accordance with the present invention.

The core network 220 provides call session control functionality 221 and user database functionality 223. The call session control functionality 221 sets up/modifies and tears down sessions between the subscriber terminal devices. The user database functionality 223 maintains information relating to subscribers, such as authentication and authorization information, presence information, location information, billing information. The call session control functionality 221 preferably supports the standardized SIP protocol and can be realized by a variety of network architectures (e.g., SIP Network, IMS Network) based thereon. A SIP Network includes a set of network elements (e.g., Registrar, Location Server(s), Proxy Server(s), Redirect Server(s)) for supporting the SIP protocol. An IMS Network is based upon the SIP protocol and embodies a set of network functions (including P-CSCF, I-CSSF, S-SCSF, BGCF, SGW, MGCF, MGW) for setting up, modifying and tearing down sessions between the subscriber terminal devices. It also includes a Home Subscriber Server (HSS), which is a master database containing subscriber-related information, such as authentication and authorization information, presence information, location information, billing information.

The mobile subscriber terminals 211A embody the media-based call alert communication application 11 as described herein and shown in the exemplary architecture of FIG. 10A. Similarly, the subscriber terminals 211B, 211C, 211D embody the media-based call alert communication application 11 as described herein and shown in the exemplary architecture of FIG. 10B. A query server 209 interfaces to the core network 220. The query server 209 embodies the functionality of the query server 9 as described herein. The query server 209 exchanges subscriber-related information (e.g., subscriber presence information) with the user database functionality 223 of the core network 220 preferably by a standardized mechanism (e.g., OSA/ParlayX services). The query server 209 can also store media content for use as media-based call alerts as well as DRM information and licenses rights associated therewith. Alternatively, the query server 209 can interface to other systems that provide such information. In alternative embodiments, the query server 209 can be part of the functionality of the core network 220 and/or can interface to (or possibly be part of) one of the access networks 210A, 210B, 210C, 210D. The functionality of the query server 209 can also possibly be distributed amongst multiple network elements that are interfaced to (or part of) different parts of the communication system. The subscriber terminals 211A, 211B, 211C, 211D communicate to one another and to the query server 209 over sessions (preferably SIP sessions) that carry information via TCPIP packets communicated therebetween in order to carry out the media-based call alert communication processing described herein.

The communications network of the present invention provides for communication of media-based call alerts as described herein. It can also be used to advertise, promote, and/or merchandise a vast range of products and services. For example, it is contemplated that during the processing of the call alert on the called-subscriber terminal 5 (and/or possibly during and/or after a voice call mediated by the call alert), the application 11 operating on the called subscriber terminal 5 can activate a user interface that presents to the called subscriber one or more advertisements and possibly one or more icons/buttons that are related thereto. The advertisement(s) of the user interface can be constructed from an image file (e.g., GIF, JPEG, PNG) and/or possibly a JavaScript program or other multimedia object employing technologies such as Java, Shockwave or Flash. Such multimedia objects can represent audio and/or video advertising content. The icons/buttons of the user interface are each associated with a particular action pertaining to the displayed advertisement(s). For example, a [Buy] icon/button can provide a link to a web page for buying a product associated with the displayed advertisement, and an [Info] icon/button can provide a link to a web page that displays information for a product associated with the displayed advertisement. In the preferred embodiment, the advertisement(s) and associated icons/buttons are presented at a predetermined point in the processing of the call alert on the called-subscriber terminal 5, for example, during the setup or termination of the playing of the media content specified by the call alert.

In an alternate embodiment, the interface can offer the called subscriber the option to “save and keep” the media content of the call alert (or possibly apply other consumption restrictions related thereto) in exchange for presentation of one or more advertisements and possibly additional conditions related thereto (e.g., the called subscriber must allow for presentation of the advertisement(s) and possibly respond to the advertisement(s)). If the called subscriber elects this option, the interface presents the advertisement(s) to the called subscriber and monitors the user interaction with the advertisement(s). If the called-subscriber has satisfied the conditions of the option, the DRM license data for media content of the call alert can be updated to allow the called-subscriber to “save and keep” the media content (or possibly apply other consumption restrictions related thereto). The update of the DRM license data is preferably accomplished by carrying out media entitlement processing operations similar to those described above respect to function 119 of FIG. 2 or function 819 of FIG. 6A. This interface can also be presented to the called subscriber during the processing of the call alert on the called-subscriber terminal 5 (and/or possibly during and/or after a voice call mediated by the call alert).

The user interface of the called subscriber terminal 5 can present to the called subscriber one or more image files and/or multimedia objects that represent promotional information and/or merchandising information as well as one or more icons/buttons related thereto.

The media content specified by the call alert can itself be advertising information, promotional information and/or merchandising information as well as one or more icons/buttons related thereto.

During the processing of the call alert on the calling-subscriber terminal 3 (and/or possibly during and/or after a voice call mediated by the call alert), the application 11 operating on the calling-subscriber terminal 3 can activate a user interface that presents to the calling subscriber one or more advertisements and possibly one or more icons/buttons that are related thereto. The advertisement(s) of the user interface can be constructed from an image file (e.g., GIF, JPEG, PNG) and/or possibly a JavaScript program or other multimedia object employing technologies such as Java, Shockwave or Flash. Such multimedia objects can represent audio and/or video advertising content. The icons/buttons of the user interface are each associated with a particular action pertaining to the displayed advertisement(s). For example, a [Buy] icon/button can provide a link to a web page for buying a product associated with the displayed advertisement, and an [Info] icon/button can provide a link to a web page that displays information for a product associated with the displayed advertisement. In the preferred embodiment, the advertisement(s) and associated icons/buttons are presented at a predetermined point in the processing of the call alert on the calling-subscriber terminal 3, for example, during the “ring-back” period where the call alert is being communicated to the called-subscriber terminal 5 but before the called-subscriber terminal 5 actually plays the media content of the call alert.

In an alternate embodiment, the interface can offer the calling subscriber the option to “save and keep” the media content of the call alert (or possibly apply other consumption restrictions related thereto) in exchange for presentation of one or more advertisements and possibly additional conditions related thereto (e.g., the calling subscriber must allow for presentation of the advertisement(s) and possibly respond to the advertisement(s)). If the calling subscriber elects this option, the interface presents the advertisement(s) to the calling subscriber and monitors the user interaction with the advertisement(s). If the calling-subscriber has satisfied the conditions of the option, the DRM license data for media content of the call alert can be updated to allow the calling-subscriber to “save and keep” the media content (or possibly apply other consumption restrictions related thereto). The update of the DRM license data is preferably accomplished by carrying out media entitlement processing operations similar to those described above respect to function 119 of FIG. 2 or function 819 of FIG. 6A. This interface can be presented to the calling subscriber during the processing of the call alert on the calling-subscriber terminal 3 (and/or possibly during and/or after a voice call mediated by the call alert).

The user interface of the calling subscriber terminal 3 can present to the called subscriber one or more image files and/or multimedia objects that represent promotional information and/or merchandising information as well as one or more icons/buttons related thereto.

The advertising information, promotional information and/or merchandising may be selected for the calling subscriber or the called subscriber by referencing user profile and/or user behavior information in the server, as well as additional reference information from third party servers, in order to identify at least one specific advertising/marketing/promotional media item to increase the applicability of the media item for the calling subscriber or called subscriber.

The advertising content of the user interface as well as the icons/buttons of the user interface and the particular actions associated therewith can be distributed to the called-subscriber terminal 5 and/or the calling-subscriber terminal 3 by many means. For example, the advertising content (or references thereto) can be forwarded to a respective subscriber terminal over communication between a central Ad Server/Ad Server Network (labeled as 17 in FIGS. 1 and 217 in FIG. 9) and the respective subscriber terminal. The advertising information communicated to a subscriber terminal can be targeted based on contextual information and/or subscriber-specific profile information, e.g., demographics, location, behavioral information (such as purchase history and/or immediate-recent actions registered by the user interface) and/or other information provided by the subscriber. The subscriber-specific profile information is preferably stored in the query server 9 and made accessible to the Ad Server as needed.

In the preferred embodiment, the application 11 executing on the respective generates and sends a request to the Ad Server. The request is associated with targeted advertising space (e.g., a particular portion of a display screen for banner-type advertisements or video advertisements) encountered by execution of the application 11 executing on a respective terminal (3, 5). The request is received by the Ad Server and processed to select advertising content based upon selection criteria (e.g., geographical targeting criteria, contextual targeting criteria, behavioral targeting criteria, etc). The selected advertising content and possibly the icons/buttons and particular actions associated therewith (or reference(s) thereto) is/are returned to the respective terminal (3, 5) where it is presented to the subscriber as part of the user interface of the respective terminal. Similar operations can be used to communicate promotional material and/or merchandising material to the respective terminal (3, 5). The respective terminal (3, 5) and the Ad Server preferably cooperate to enable the Ad Server to track impressions, clicks, post-click activities, and possibly other interaction metrics for the advertisement content communicated to the respective terminal, and to allow advertisers to monitor progress of their advertising campaigns based upon such metrics.

The application 11 operating on the respective terminal (3, 5) can provide the subscriber with opt-in/opt-out permission control over the receiving of advertisement(s) and/or other promotional and marketing information during the media-based call alert processing described herein. Such opt-in/out-out control can be provided on a global basis (for all functions controlled by the service) or possibly on a type-by-type basis (for certain functions controlled by the service, such as, opt-in for receiving advertisements pertaining to called-subscriber functions and opt-out for receiving “ring-back” advertisements pertaining to calling-subscriber functions).

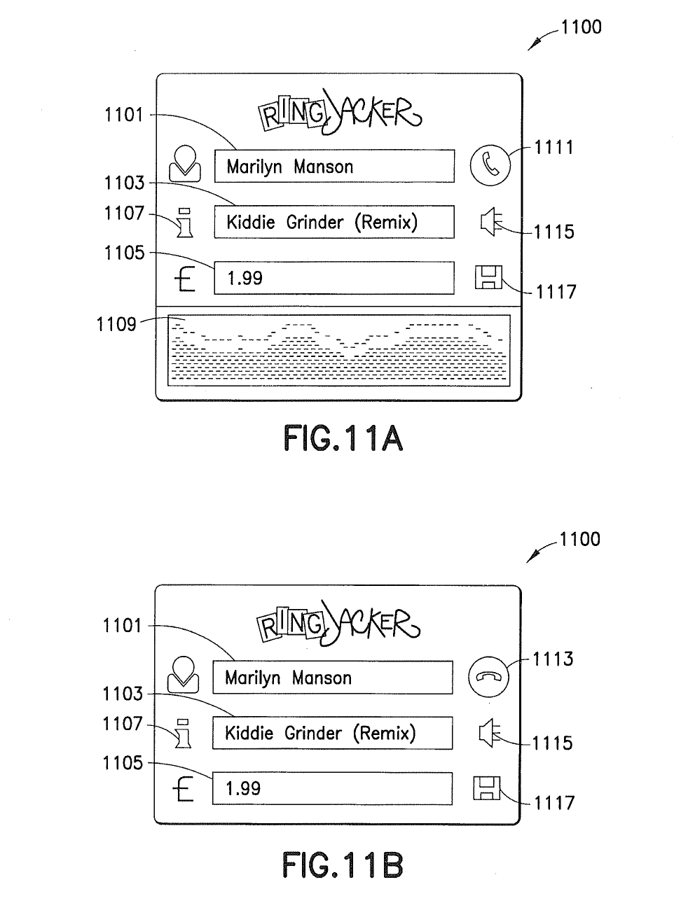

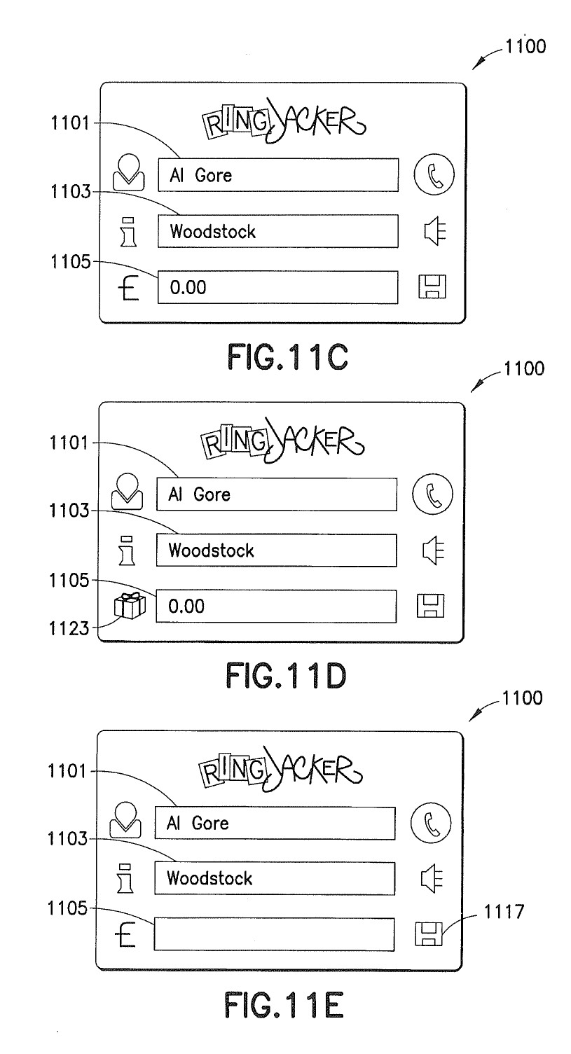

In accordance with another aspect of the invention, the application 11 operating on the terminals 3, 5 of the exemplary communication systems described herein invokes a graphical user interface that is presented to the called subscriber as part of a media-based voice call to the called subscriber. The graphical user interface enables the called subscriber to review and purchase the media content of the call alert communicated thereto as well as enables the called subscriber to access information or actions associated with such media content. An example of such a graphical user interface is shown in FIGS. 11A through 11E. The interface 1100 is updated depending on the call state of the called subscriber terminal. FIG. 11A illustrates the interface 1100 presented to the called subscriber when an incoming media-based call alert is being played on the called-subscriber terminal. FIG. 11B illustrates the interface 1100 presented to the called subscriber when a voice call is in progress (i.e., the incoming call has been accepted by the called subscriber).

The interface of FIG. 11A includes a text box 1101 that identifies the calling subscriber (e.g., the short name or number assigned to the calling subscriber) that initiated a media-based voice call to the called subscriber. A text box 1103 identifies the title of the media content of the call alert specified by the calling subscriber. The media content of the call alert can be stored locally on the called-subscriber terminal or possibly on a remote system as described herein. A text box 1105 identifies a money (or alternatively loyalty point) amount for purchasing the media content of the call alert. An icon 1107 is a hyperlink to information pertaining to the media content of the call alert. A window 1109 is presented preferably on the bottom portion of the interface as shown. The window 1109 displays information associated with the playback of the content of the call alert and thus is updated depending on the type of content of the call alert. For example, when audio content or music content is played as the call alert, the window 1109 displays an audio oscilloscope as shown. When video content is played as the call alert, the window 1109 displays the video content of the call alert. When image content (e.g., pictures, image sequence, avatar, Flash program, etc.) is played as the call alert, the window 1109 displays the image content of the call alert. When an advertisement or script is played as the call alert on the called subscriber terminal, the window 1109 displays the advertisement or information rendered by the script. The playback window 1109 can include transport controls affecting the playback (such as start, stop, pause, volume control, mute, etc.). After the playback of such content has ended, the window 1109 automatically disappears. For small size displays (such as mobile phones), the display of playback window 1109 can override and replace the display of the interface 1100 (or a portion thereof). The interface 1100 also includes an icon 1111 that can be selected by the called subscriber to accept the incoming voice call. After such acceptance, bidirectional peer-to-peer voice communication is carried out between the called-subscriber terminal 5 and the calling-subscriber terminal 3 as described herein.

After the incoming call has been accepted by the called subscriber, the interface of FIG. 11B is presented to the called subscriber. The interface of FIG. 11B includes a text box 1101 that identifies the calling subscriber (e.g., the short name or number assigned to the calling subscriber). A text box 1103 identifies the title of the media content of the call alert that announced the call. The media content can be stored locally on the called-subscriber terminal or possibly on a remote system. A text box 1105 identifies a money amount for purchasing the media content of the call alert. An icon 1107 is a hyperlink to information pertaining to the media content of the call alert. In place of the icon 1111 of FIG. 11A, an icon 1113 is presented that can be selected by the called subscriber for terminating the voice call between the called-subscriber terminal 5 and the calling-subscriber terminal 3. An icon 1115 can be selected by the called subscriber to initiate playback of the media content of the call alert during the call. In the preferred embodiment, selection of icon 1115 by the called subscriber allows for both the called subscriber and the calling subscriber parties to hear or view the media content of the call alert. An icon 1117 can be selected by the called subscriber in order to allow the called subscriber to initiate a purchase transaction for the media content of the call alert. The purchase amount for the media content is provided in text box 1105. The DRM license data can place restrictions on access to the media content listed in text box 1115, for example by not allowing replaying of the media content. When the purchase transaction is complete, the DRM license data associated with the media content can be updated as described above.

The media content of the call alert can be offered for free (possibly for promotional purposes) or gifted by the calling subscriber. In such cases, the purchase amount of text box 1105 will be zero (e.g., “0.00”) and a gift icon 1123 presented to the user to reflect the fact that the called subscriber will not incur any fees by activation of icon 1117 as shown in FIGS. 11C and 11D). The DRM license data of the media content of the call alert can place restrictions on access to the media content, for example by denying subsequent purchase and access to the media content. In such a case, the purchase amount of text box 1105 is blank and the icon 1117 deactivated (e.g., grayed out) to reflect the access limitations imposed on the media content of the call alert as shown in FIG. 11E.

In alternate embodiments, the calling subscriber can control the playback actions of the media content of the call alert on the called-subscriber terminal 5, for example by setting preferences presented to the calling subscriber on the calling-subscriber terminal 3. The playback can be selected to occur upon receipt of the media content at the called-subscriber terminal or possibly upon the called subscriber activating an icon or other user interface element presented to the called subscriber on the called subscriber terminal during initiation of the voice call.

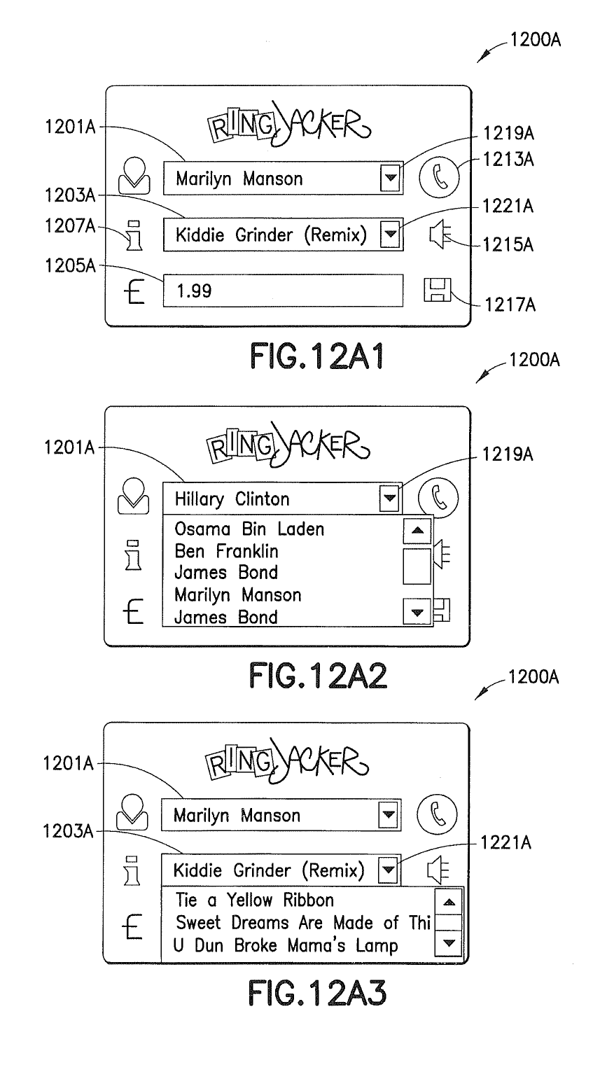

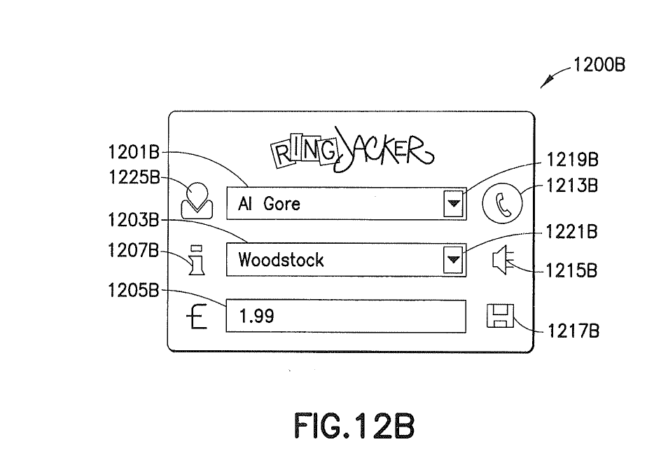

The application 11 operating on the terminals 3, 5 of the exemplary communication systems described herein also preferably employs a graphical user interface that provides a user-friendly mechanism for initiating media-based voice calls as well a user-friendly mechanism for presenting an interactive history of the media-based call alerts received and/or played on the terminal devices of the system. An example of such a graphical user interface is shown in FIGS. 12A1-12B. The graphical user interface includes two states: a first state 1200A as shown in FIGS. 12A1-12A3 and a second state 1200B as shown in FIG. 12B. The first state 1200A provides a user-friendly mechanism for initiating media-based voice calls. The second state 1200B provides a user-friendly mechanism for presenting an interactive history of the media-based call alerts received and/or played on the terminal devices of the system. The two states 1200A and 1200B preferably share common elements and layout as is evident from the drawings. The states 1200A and 1200B also employ a layout similar to the interface 1100 that is presented to that is presented to the called subscriber as part of a media-based voice call to the called subscriber as described above with respect to FIGS. 11A-11E. The states 1200A and 1200B can be invoked and presented to the subscriber as deemed appropriate (for example during startup of the application, in response to user interaction with another display screen or other user input, automatically depending on the call state of the terminal, e.g., when the terminal is idle and no voice call is in progress, or in response to other events).

As shown in FIGS. 12A1-12A3, the first state 1200A includes a text box 1201A that identifies a subscriber (e.g., the short name or number assigned to a subscriber). Preferably, the subscriber listed in text box 1201A is part of the subscriber's buddy list, which is accessed by pull down tab 1219A. The subscriber can scroll down the menu and select any one of the listed subscribers as shown in FIG. 12A2. The selected subscriber is then listed in the text box 1201A. The text box 1203A identifies the title of media content that is available for use as call alert. A pull down tab 1221A enables the subscriber to access a menu that identifies media content titles that are available for use as call alerts. The subscriber can scroll down the menu and select any one of the listed media content titles as shown in FIG. 12A3. The selected media content title is then listed in the text box 1203A. The media content can be stored locally on the terminal or possibly on a remote system for subsequent access and use in media-based calls that are initiated from the terminal devices of the system.

The first state 1200A also includes a text box 1205A that identifies a money amount for purchasing the media content identified in text box 1203A. An icon 1207A is a hyperlink to information pertaining to the media content identified in text box 1203A. An icon 1213A is presented that can be selected by the subscriber to initiate a media-based voice call to the subscriber identified in text box 1201A utilizing the media content listed in text box 1203A as the call alert of the call. An icon 1215A can be selected by the subscriber to initiate playing of the media content identified in text box 1203A for preview purposes. The playback of the media content can involve displaying of a playback window as described above with respect to FIGS. 11A-11E. The playback window can be displayed along with the first state 1200A. For small size displays (such as mobile phones), the display of playback window can override and replace the display of the first state 1200A (or a portion thereof). An icon 1217A can be selected by the subscriber to initiate a purchase transaction (or other transaction such as a gift transaction) for the media content identified in text box 1203A. The purchase amount for the media content is provided in text box 1205A. When the transaction is complete, the DRM license data associated with the media content can be updated as described above. The DRM license data can place restrictions on access to the media content listed in text box 1203A, for example by not allowing replaying of the media content. In such a case, icon 1215A can be deactivated (e.g., grayed out) to reflect the access limitations imposed on the media content. The media content listed in text box 1203A can be offered for free (possibly for promotional purposes), gifted from another subscriber, or already purchased by the subscriber. In such cases, the purchase amount of text box 1205A will be zero (e.g., “0.00”) and the icon 1217A can be grayed-out to reflect that purchase is not necessary.

Other actions can be triggered from elements of the first state 1200A of FIGS. 12A1-12A3. For example, the system can maintain a database of media content for particular subscribers and provide access to the content over the Web or other suitable access mechanism. Selection of the caller icon 1225B can offer the user several options including, but not limited to, managing permissions, deleting addressee, access the media content of the subscriber specified in text box 1201B as stored in the database, for example by linking to a Web view for the media content of the specified subscriber, or to add a new addressee.

As shown in FIG. 12B, the second state 1200B includes a text box 1201B that identifies a calling subscriber (e.g., the short name or number assigned to the calling subscriber) for a call alert previously communicated to the terminal device. Preferably, the text box 1201B is initialized to identify the calling subscriber of the last call alert communicated to the terminal device. A pull down tab 1219B enables the subscriber to access a menu that identifies the calling subscriber for call alerts previously communicated to the terminal device. The subscriber can scroll down the menu and select any one of the listed subscribers in a manner similar to that shown in FIG. 12A2. The selected subscriber is then listed in the text box 1201B. The text box 1203B identifies the title of the media content of a call alert for the subscriber listed in text box 1201B. A pull down tab 1221B enables the subscriber to access a menu that identifies the media content titles for call alerts previously communicated to the terminal device. Preferably, the menu accessed by pull down tab 1221B lists call alerts ordered by subscriber according to the subscriber list accessed by pull down tab 1219B. The subscriber can scroll down the menu and select any one of the listed media content titles in a manner similar to that shown in FIG. 12A3. The selected media content title is then listed in the text box 1203B. The text box 1201B can be updated to identify the calling subscriber for the call alert listed in text box 1203B if need be. The media content can be stored locally on the terminal or possibly on a remote system for subsequent access and use in media-based calls that are initiated from the terminal.

The second state 1200B of FIG. 12B also includes a text box 1205B that identifies a money amount for purchasing the media content identified in text box 1203B. An icon 1207B is a hyperlink to information pertaining to the media content identified in text box 1203B. An icon 1213B is presented that can be selected by the subscriber to initiate a media-based voice call to the subscriber identified in text box 1201B utilizing the media content listed in text box 1203B as the call alert of the call. An icon 1215B can be selected by the subscriber to initiate playing of the media content identified in text box 1203B for preview purposes. The playback of the media content can involve displaying a playback window as described above with respect to FIGS. 11A-11E. The playback window can be displayed along with the second state 1200B. For small size displays (such as mobile phones), the display of playback window can override and replace the display of the second state 1200B (or a portion thereof). An icon 1217B can be selected by the subscriber to initiate a purchase transaction (or other transaction such as a gift transaction) for the media content identified in text box 1203B. The purchase amount for the media content is provided in text box 1205B. When the transaction is complete, the DRM license data associated with the media content can be updated as described above. The DRM license data can place restrictions on access to the media content listed in text box 1203B, for example by not allowing replaying of the media content. In such a case, icon 1215B can be deactivated (e.g., grayed out or dynamically replaced with another icon) to reflect the access limitations imposed on the media content. The media content listed in text box 1203B can be offered for free (possibly for promotional purposes), gifted from another subscriber, or already purchased by the subscriber. In such cases, the purchase amount of text box 1205B will be zero (e.g., “0.00”) and the icon 1217B can be grayed-out or dynamically replaced with another icon to reflect that purchase is not necessary or not applicable.

Other actions can be triggered from elements of the second state 1200B of FIG. 12B. For example, the system can maintain a database of media content for particular subscribers and provide access to the content over the Web or other suitable access mechanism. Selection of the caller icon 1225B can access the media content of the subscriber specified in text box 1201B as stored in the database, for example by linking to a Web view for the media content of the specified subscriber.

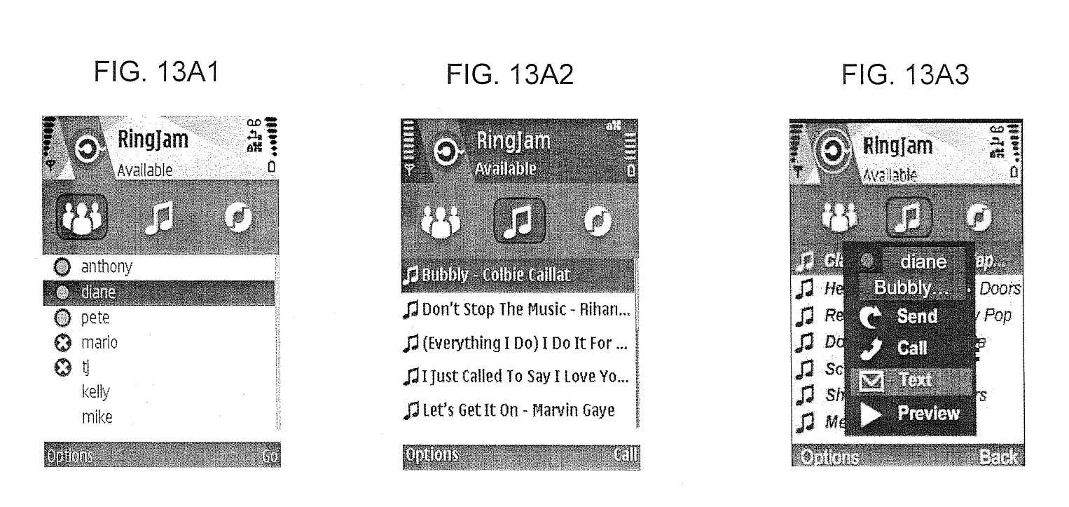

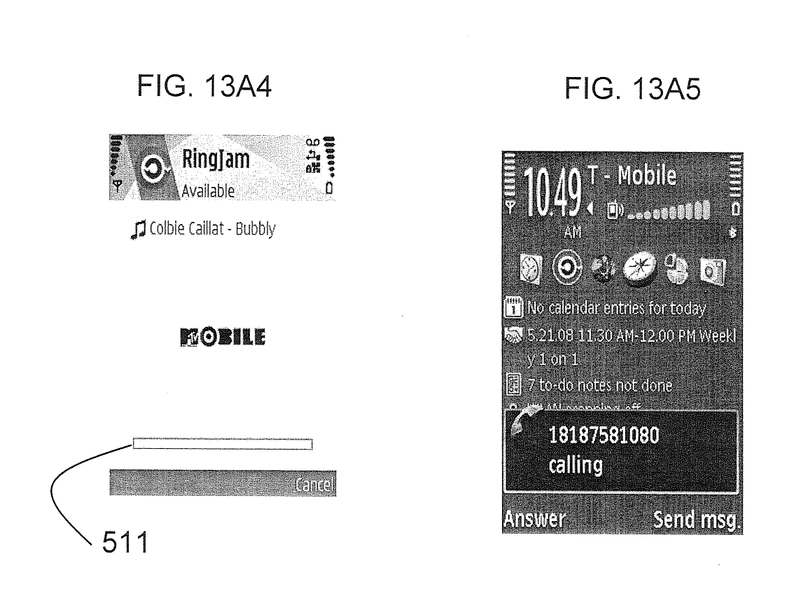

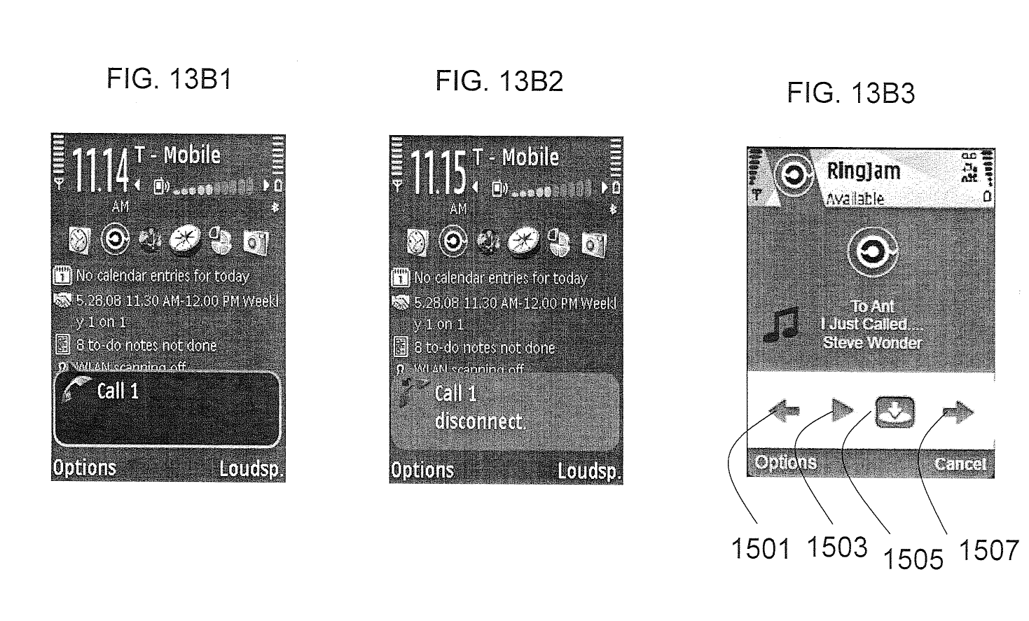

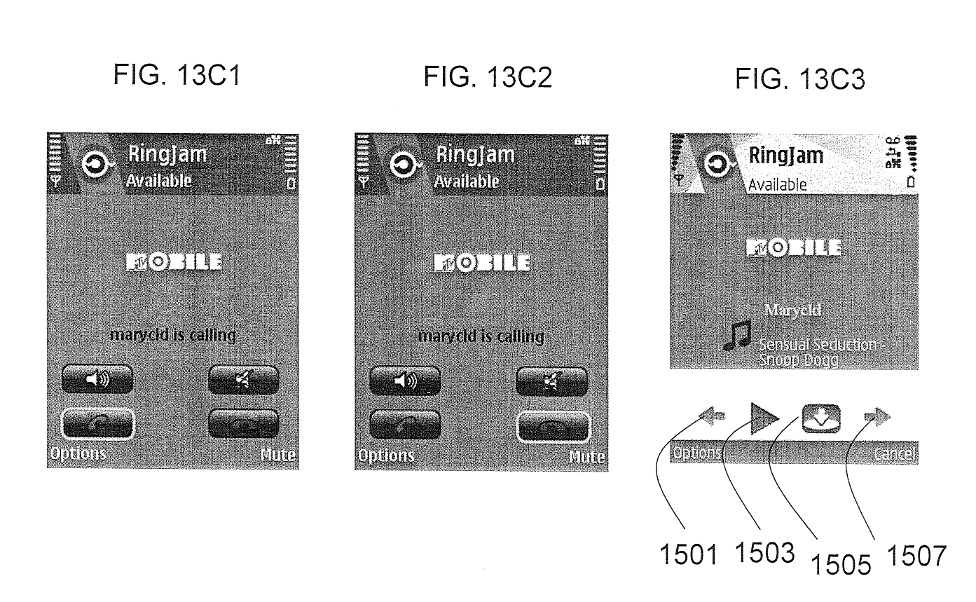

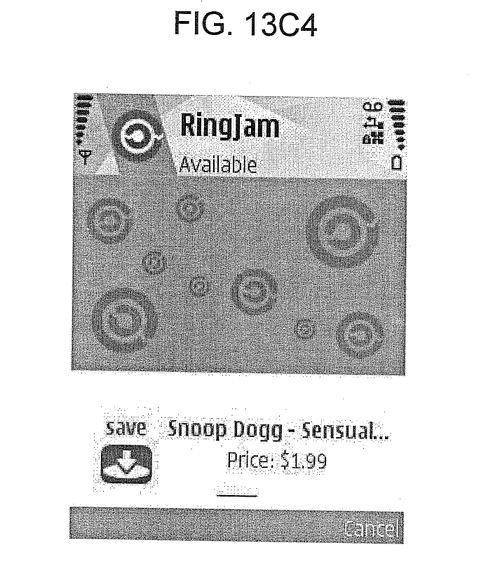

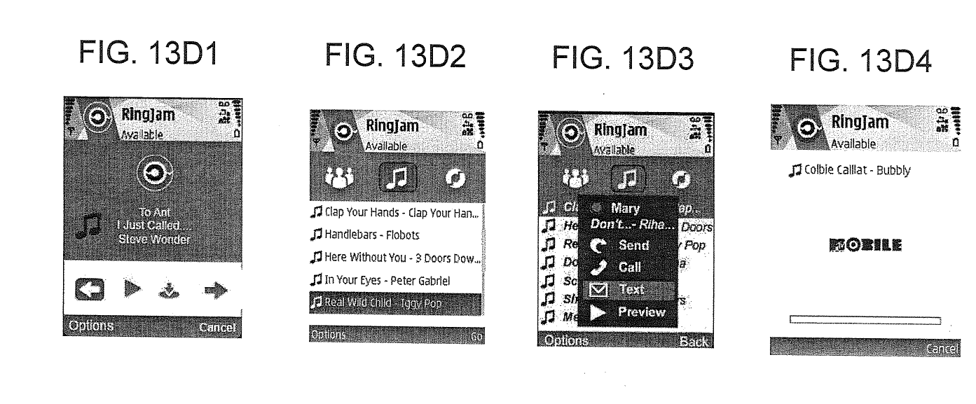

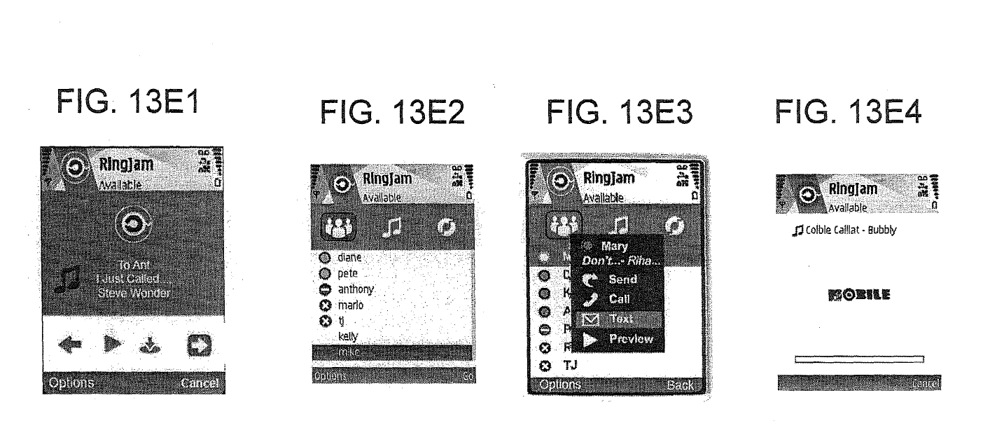

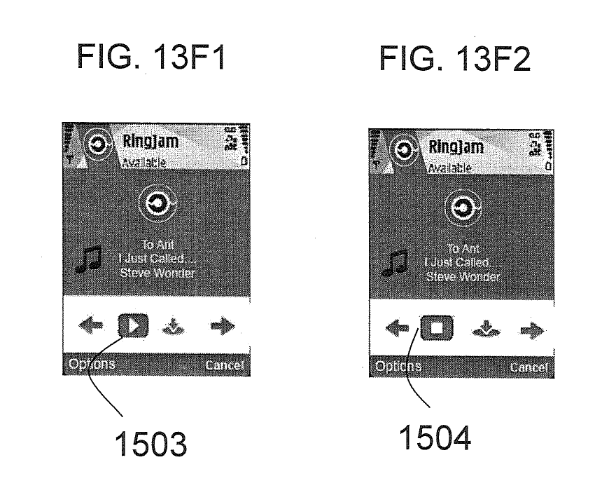

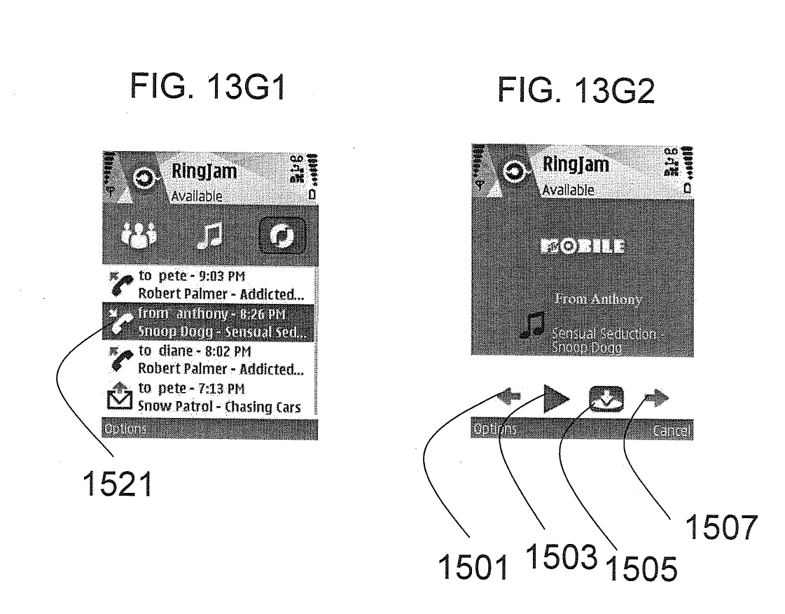

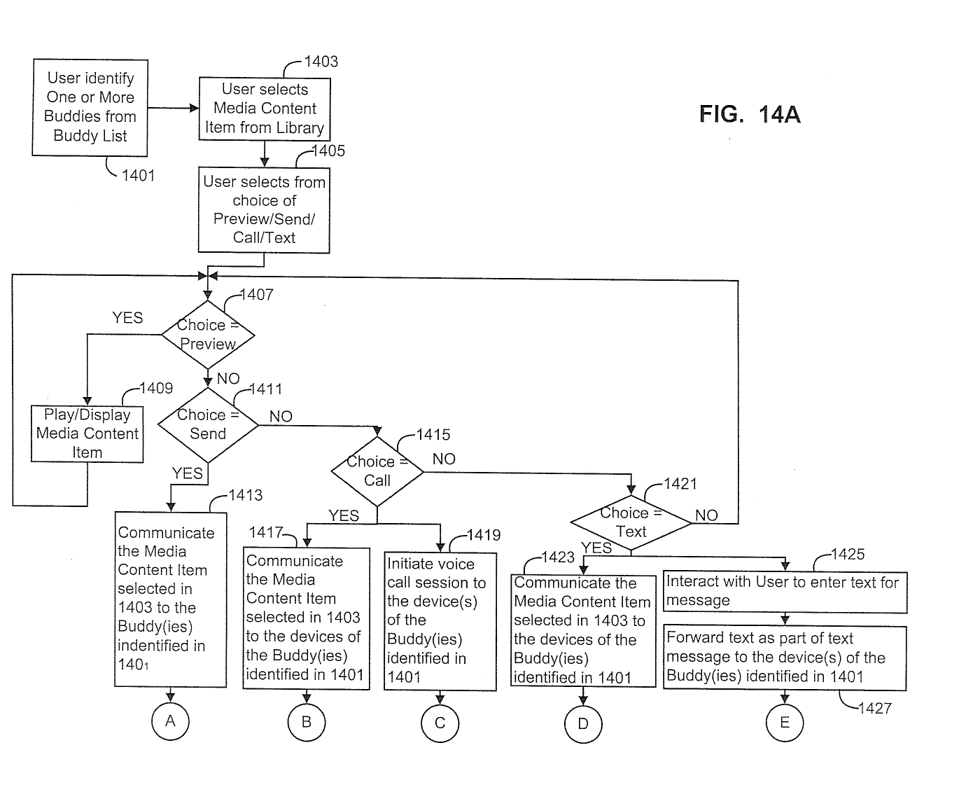

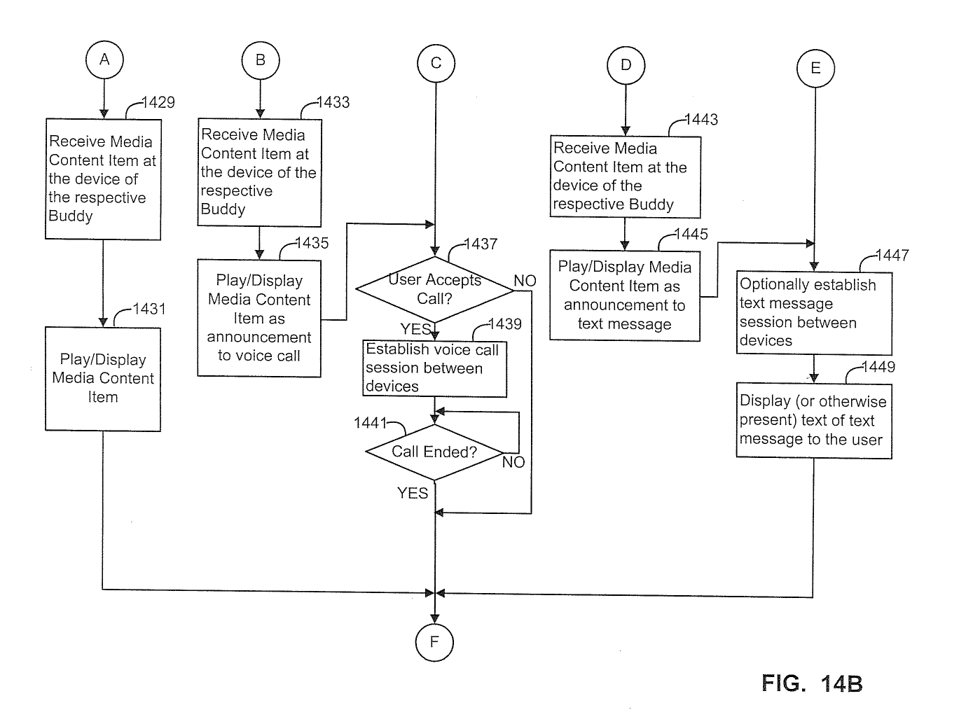

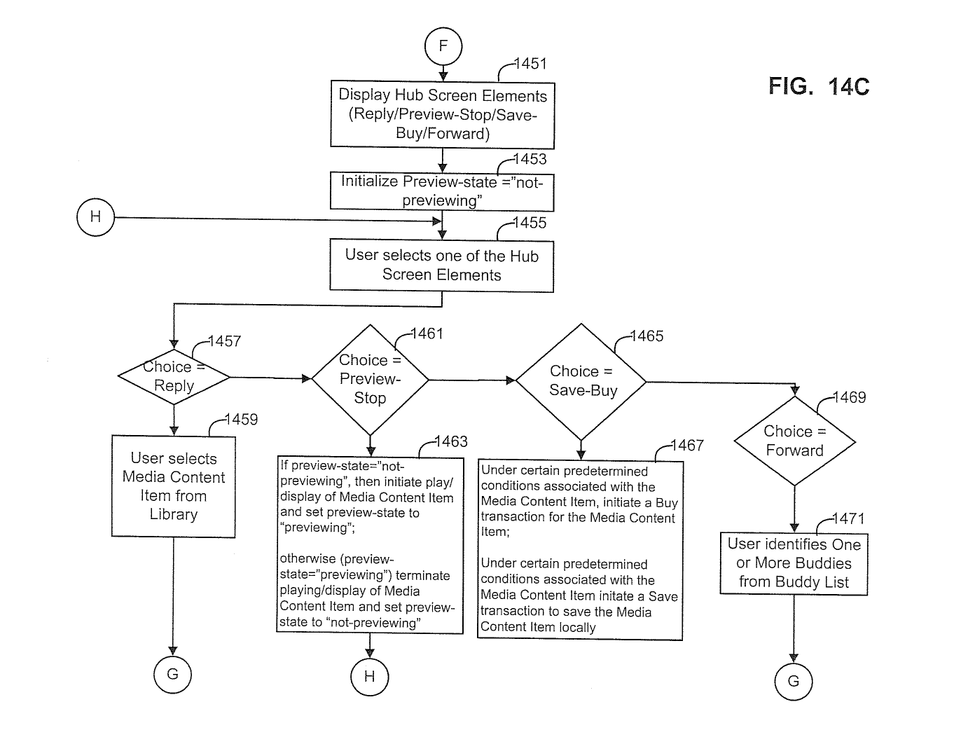

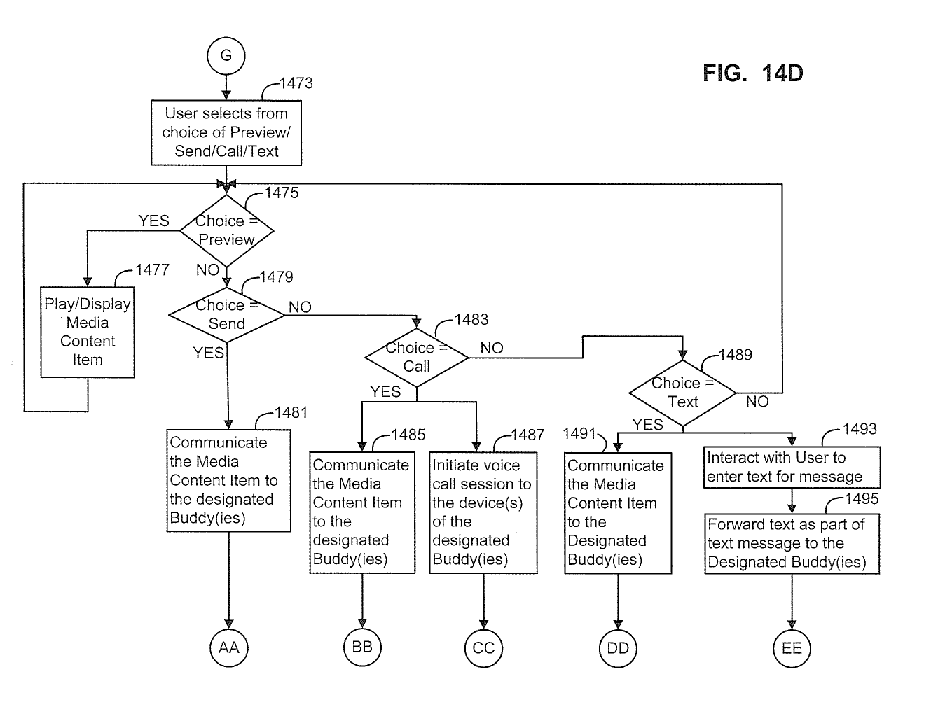

In accordance with yet another aspect of the invention, the application 11 operating on the terminals 3, 5 of the exemplary communication systems described herein invokes a graphical user interface that provides a user-friendly mechanism for initiating communication employing media content to one or more parties as well as a user-friendly mechanism for the parties to receive such communication and to review and/or purchase the media content as well as perform actions (e.g., forward and reply actions) associated with such media content. The graphical user interface also provides a user-friendly mechanism for presenting an interactive history of the communications and associated media content received by and/or sent from the respective terminal devices of the system. An example of such a graphical user interface is shown in FIGS. 13A1 through 13G2 in conjunction with the flow chart of FIGS. 14A through 14D. Note that the respective terminal devices each include a keypad and/or touchscreen or other pointing device that allows for user selection of one or more elements of the respective display menus set forth below as is well known in the communication arts.

The graphical user interface begins in block 1401 by displaying a buddy list (FIG. 13A1) that presents a list of one or more subscribers that have been identified by the user as a buddy or friend or other party of interest. A subscriber is added to the list via user selection from an options menu, as illustrated by “Options” at the lower left corner of the display, which can vary for different service providers, vendors and devices. Preferably, the buddy list for a given subscriber is created by execution of the application on a respective subscriber terminal device by the given subscriber and uploaded to the query server for remote storage therein. The buddy list can be downloaded to the application for access by the given subscriber as needed. The user selects one or more the subscribers on the list and the operations continue to block 1403.

In block 1403, the user is presented with a list of media content items (FIG. 13A2). One or more media content items of the list can be stored locally on the subscriber terminal as described above (e.g., a ring tone, image or video tone downloaded from a content source or communicated from another user, captured by a camera and/or microphone integral to the terminal device, or introduced into the application by the user through a different method, e.g., through content side loading from a personal computer or other device). Alternatively, one or more media content items of the list can be stored remotely on a content source as described above. It is contemplated that the user can add media content items to the list via user selection from an options menu, as illustrated by “Options” at the lower left corner of the display. The user selects one of the media content items on the list and the operations continue to block 1405.

In block 1405, a pop-up display window presents the user with a list of actions for selection by the user (FIG. 13A3). These actions include a “Preview” action, “Send” action, “Call” action, and “Text” action. The “Preview” action, when selected by the user, initiates a process (blocks 1407 to 1409) that allows for playback/display of the media content item selected in block 1403. The “Send” action, when selected by the user, initiates a communication process (blocks 1411 to 1413) that communicates the media content item selected in block 1403 to the one or more users selected in block 1401. The “Call” action, when selected by the user, initiates a communication process (blocks 1415 to 1419) that communicates the media content item selected in block 1403 to the one or more users selected in block 1401 as well as initiates a voice call session to such users. The “Text” action, when selected by the user, initiates a communication process (blocks 1421 to 14127) that communicates the media content item selected in block 1403 to the one or more users selected in block 1401 as well as interacts with a user to enter text for a text message and forwards the text message to the user selected in block 1401. FIGS. 13A4 and 13A5 illustrate the display screens presented to a calling user in conjunction with the “Call” action process of bocks 1415 to 1419. The display screen of FIG. 13A4 includes a status bar 511 that is intended to depict the status of the overall process that communicates the media content item to the user selected in block 1401. In the preferred embodiment, the media content item is played or displayed (possibly along with an advertisement) on the receiving user terminal device while this status bar is progressing (blocks 1411 to 1413). The display screen of FIG. 13A5 depicts the status of the network operations that call the user selected in block 1401. The display screen of FIG. 13A5 can be integrated as part of the operating system of the terminal device, and thus can vary for different service providers, vendors and devices.

Turning now to FIG. 14B, the respective terminal devices include communication processes and a supporting graphical user interface for receiving the sender-initiated communication as described above with respect to FIG. 14A. The process of blocks 1429 to 1431 receives the media content item communicated via the “Send” action of blocks 1411 to 1413 and then plays (or displays) the media content item on the terminal device. After playback (or display) of the media content item is terminated by the user or otherwise ends, the process of blocks 1429 to 1431 continues to block 1451.

The process of blocks 1433 to 1441 receives the media content item communicated via the “Call” action of blocks 1415 to 1419 and then plays (or displays) the media content item as an announcement for the incoming voice call. If the user accepts the incoming call, a voice call session is established between the terminal devices to allow for voice communication therebetween. If the user does not accept the incoming call (or the call ends or is otherwise terminated), the process of blocks 1433 to 1441 continues to block 1451. FIGS. 13B1 and 13B2 are exemplary display screens that are presented to a receiving party when accepting (or declining) an incoming voice call as well as when terminating the voice call as part of the process of blocks 1433 to 1441. The display screens of FIGS. 13B1 and 13B2 can be integrated as part of the operating system of the terminal device and thus can vary for different service providers, vendors and devices. FIGS. 13C1 and 13C2 are other display screens that can be presented to a receiving party when accepting (or declining) an incoming voice call as well as when terminating the voice call as part of the process of blocks 1433 to 1441. Such display screens are intended for use in conjunction with voice calls carried over a VOIP connection as is well known in the art.

The process of blocks 1443 to 1449 receives the media content item communicated via the “Text” action of blocks 1421 to 1427 and then plays (or displays) the media content item as an announcement for the incoming text message. After displaying or otherwise presenting the text message to the use, the process of blocks 1443 to 1449 continues to block 1451.

In block 1451, the user is presented with a hub screen (FIGS. 13B3 and 13C3) that presents the user with information regarding the immediately prior incoming communication. Such information includes information that identifies the sending party that originated the communication as well as information (such as title/filename and artist/creator name) for identifying the media content item of the communication as shown. The hub screen also includes a set of graphical icons that provide for a set of predetermined actions associated with the media content item of the communication. In the preferred embodiment, the predetermined actions include a “Reply” action (icon 1501), “Preview” and “Stop” actions (the Preview icon is shown as 1503, the Stop icon is shown as 1504 in FIG. 13F2), “Save” or “Buy” actions (icon 1505), and a “Forward” action (icon 1507). The “Reply” action, when selected by the user in block 1455, initiates a process (blocks 1457 to 1495) that allows the user to select a media content item from a list of media content items and then initiate a communication (Send/Call/Text communication) back to the party that originated the prior incoming communication. The “Forward” action, when selected by the user in block 1455, initiates a process (blocks 1469 to 1495) that allows the user to select a user from a buddy list that presents a list of one or more subscribers that have been identified by the user as a buddy or friend or other party of interest and then initiates a communication (Send/Call/Text communication) to that selected user employing the media content item of the prior incoming communication. The “Preview” and “Stop” actions, when selected by the user in block 1455, initiates a process (blocks 1451 to 1463) that allows the user to play (or display) the media content item of the prior incoming communication as well as terminate such playing/display. The “Save” or “Buy” action, when selected by the user in block 1455, initiates transactions for buying or saving the media content item of the prior incoming communication (blocks 1465 to 1467). In the preferred embodiment, the appropriate transaction-type (buy or save) is dictated by conditions associated with the media content item. In the preferred embodiment, in the event that the media content item is purchasable, the “Save” or “Buy” option initiates a transaction for purchasing the media content item (or associated right and/or license to the media content item) from a content store. The transaction is preferably carried out via user interaction with a point-of-sale screen (FIG. 13C4) that includes the price (and/or other terms) for purchasing the media content item alongside a second “Save” button, which serves to confirm and fulfill the sale. As part of the purchase or save transactions, the media content item can be stored locally on the terminal (possibly on a removable memory device of the terminal) and/or on a remote storage device accessible by the terminal.

Note that the “Reply”, Forward, and/or “Save or Buy” actions can be disabled for a respective media content item by restrictions embodied by DRM controls or other permissions associated the media content item. For example, it is contemplated that users can generate their own media content items (such as short audio or video clips) and set permissions for consumption of such content (e.g., Save Available, Save Unavailable, Forwarding Available, Forwarding Unavailable). The permissions associated with a given user-generated content item can be applied uniformly over all users and all communications or can vary over different users and/or different communication contexts. In this manner, the permissions set by the user can govern the actions permitted by the downstream user, e.g., permitting or forbidding the saving of the associated media content item as part of a “Save” action and/or permitting or forbidding the forwarding of the associated media content item as part of a “Forward” action. In another example, it is contemplated that commercial media content items will be protected by DRM controls that govern the consumption of such content (e.g., Save Available, Save Unavailable, Forwarding Available, Forwarding Unavailable). In this manner, the DRM controls of the media content item can govern the actions permitted by the downstream user, e.g., permitting or forbidding the saving of the associated media content item as part of a “Save” or Buy” action and/or permitting or forbidding the forwarding of the associated media content item as part of a “Forward” action. The DRM controls for a respective media content item can be updated in the event that the commercial media content has been purchased (e.g., updated from play with restrictions to save and play without restrictions upon purchase).

FIG. 14D illustrates the operations for carrying out the Send, Call, and Text communication as part of a Reply action and Forward action. Such operations are consistent with those carried out in originating Send, Call, and Text communication as described above with respect to FIG. 14A. FIGS. 13D1 to 13D4 illustrate exemplary display screens presented to the user upon user selection of the Reply action of the hub screen followed by text communication. FIGS. 13E1 to 13E4 illustrate exemplary display screens presented to the user upon user selection of the Forward action of the hub screen followed by text communication. FIGS. 13F1 and 13F2 illustrates the display screen presented the user upon user selection of the Preview action and Stop action, respectively, of the hub screen. In the preferred embodiment, the elements and layout of the display screens for carrying out the Send, Call, and Text communication as part of a Reply action and Forward action are common to those for originating Send, Call, and Text communication and thus provide a consistent and easy to learn environment.

The graphical user interface of the application 11 operating on the terminals 3, 5 also preferably provides a user-friendly mechanism for presenting an interactive history of the communications and associated media content received by and/or sent from the terminal devices of the system. An example of such an interface is illustrated in FIGS. 13G1 and 13G2. The interface includes a first display screen (FIG. 13G1) which includes a list of entries each corresponding to a particular communication received by or sent from the respective terminal device. Each entry includes the following components:
an icon 1521 selected from a plurality of icons representing different types of communication (e.g., outbound voice call, inbound voice call, outbound text message, inbound text message, inbound send, outbound send, etc.);
information (such as a shortname) that identifies the recipient for outbound communications or information (such as a shortname) that identifies the sender for inbound communications as well as time of such communication as shown; and
information (such as title/filename and artist/creator name) for identifying the media content item of the communication as shown.

The display screen of FIG. 13G1 can be invoked and presented to the user as deemed appropriate (for example during startup of the application, in response to user interaction with another display screen or other user input, automatically depending on the call state of the terminal, e.g., when the terminal is idle and no voice call is in progress, or in response to other events). The user selects one of the entries of the first screen of FIG. 13G1, which invokes presentation of the hub screen corresponding to the selected entry as shown in FIG. 13G2. The hub screen of FIG. 13G2 (which is similar to the hub screens of FIGS. 13B3 and 13C3) presents the user with information regarding the communication of the selected entry, including information that identifies the sending party that originated the communication for incoming communications or information that identifies the recipient of the communication for outgoing communications as well information (such as title/filename and artist/creator name) for identifying the media content item of the communication. The hub screen of FIG. 13G2 also includes a set of graphical icons that provide for a set of predetermined actions associated with the media content item of the communication, which preferably includes a “Reply” action, “Preview” and “Stop” actions, “Save” or “Buy” actions, and “Forward” actions as described above in detail.

Other actions can be triggered from elements of the hub screen of FIGS. 13B3, 13C3, and 13G2. For example, the system can maintain a database of media content for particular subscribers and provide access to the content over the Web or other suitable access mechanism. In another example related to game-play, the title (or artist) of the media content item can be blanked out (or otherwise hidden) from the receiving party during playback and the hub screen can enable the receiving user to name the title (or artist) of the media content item as part of game challenge. The game challenge can be carried out by presenting the user with an offer (e.g., “Name that tune?”) together with a “Yes” button. User selection of the “Yes” button triggers presentation of a user-input screen that allows the user to enter in the title (or artist) of the media content item, communicate such information to a network node for handling the game challenge, receiving communication back from this network node the results of the game challenge, and presenting such results to the user (e.g., “You have won—your guess is correct” or “You have lost—your guess is incorrect”). It is contemplated that users can selectively control (e.g., by global or user-specific “block” permissions) whether or note such game challenges can be communicated to (and/or presented on) the user device when originating from particular users (and/or from all users). In other embodiments, the display of the hub screen can be presented to the user in conjunction with other multimedia content, such as an audio clip or a vibratory ringer. Such multimedia content can be specified by the sending party or optionally integrated into the communication flow by an intermediate node of the system.

Additionally, the graphical user interfaces described herein can be extended to provide additional features, such as showing the progress of transactions or peer-to-peer content transfers or back-and-forth peer-to-peer communication of media content during an ongoing communication session.

Advantageously, the graphical user interfaces described herein offer a frictionless user experience and an opportunity to execute an impulse purchase of the media content as well as enable the recipient to quickly and efficiently locate information related to the media content. They are used in conjunction with a communication system that provides for viral distribution of media content and thus offer significant potential revenue growth from the repetitious act of sharing media within and between and network of peers and commercialization of the media content.

The peer-to-peer voice communication operations described herein can be extended to multiple party voice communications. For example, parties can be added to a multiple-party voice conference utilizing any suitable mechanism, including dial-in methods to a central service and dial-out methods from the service. For dial-out methods, the media-based call alert processing described herein can be used to alert the user of the conference call request. Moreover, when the service is used to connect two or more parties, the query server can identify the location of the parties, sequester information related to such locations, and offer to the parties products or services related to such locations, which are typically referred to as Location-based services. For example, in a multiple party call, any or all of the users can be offered the ability to view the relative proximity of the other party(ies) of the call or to receive a turn-by-turn instructions (and/or map) for traveling to one or more of the other party(ies) of the call.

Moreover, the peer-to-peer communication operations as described herein can be extended to other peer-to-peer communication systems, such as SMS text messaging systems, MMS messaging systems, IM messaging systems, Push-to-Talk systems and/or other peer-to-peer communication systems. In these systems, the party that is initiating the communication (“the sending party”) specifies the other party (“the receiving party”). The sending party also specifies media content for the communication. The sender-specified media content (or a reference to such media content) is communicated to the receiving party device and played or displayed on the receiving party device in conjunction with the communication associated therewith. Such communication can be supplemented with ancillary data communication (e.g., video data for a video call, data exchange for whiteboarding, calendar event sharing, file sharing or other collaborative features). In the preferred embodiment, the sender-specified media content is played or displayed on the receiving party device to announce or solicit or otherwise engage in the communication. Alternatively, the sender-specified media content can be communicated to and played or displayed on the receiving party device without soliciting or engaging in other communication. For example, the sending-party specified media content can be part of a basic media push action as described herein. In another example, the sending-party specified media content can be a pop-up display whereby the sending party challenges the receiving party to engage in a head-to-head game (e.g., a pop-up window displaying “Anthony challenges you to a game of ping-pong. Winner gets 10 points. Select “Serve” to begin”. The receiving party can interact with the window to engage in the game (e.g., by selecting the “Serve” option).

Moreover, the communication operations as described herein can be extended to multiple party communication systems, such as multi-party texting, multi-party IM conferencing, multiplayer gaming, etc. In these systems, the party that is initiating the communication (“the sending party”) specifies other parties (“the receiving parties”). The sending party also specifies media content for the communication. The sender-specified media content (or a reference to such media content) is communicated to each respective receiving party device and played or displayed on each respective receiving party device in conjunction with the communication associated therewith. Such communication can be supplemented with ancillary data communication (e.g., video data for a video call, data exchange for whiteboarding, calendar event sharing, file sharing or other collaborative features). In the preferred embodiment, the sender-specified media content is played or displayed on each respective receiving party device to announce or solicit or otherwise engage in the communication. Alternatively, the sender-specified media content can be communicated to and played or displayed on each respective receiving party device without soliciting or engaging in other communication. For example, the sending-party specified media content can be part of a basic media push action or game challenge as described herein.

The communication of messages, commands and media content between network elements (i.e., the subscriber terminals, the query server, the ad server, etc.) as part of the communication framework described herein can be carried out using a wide variety of communication protocols. In the preferred embodiment described above, such communication is carried out using an IP networking protocol in conjunction with the Session Initiation Protocol (SIP) protocols in order to set up a communication session to the called party device. Once set up, the communication sessions employ Real-time Transport (RTP) packets as the carrier of the information itself. In alternate embodiments, other application layer protocols (instead of SIP, e.g., XMPP) can be used to establish communication sessions between network elements. In yet other alternate embodiments, other transport layer protocols (instead of RTP) can be used to carry information between the network elements. For example, it is contemplated that the Message Session Relay Protocol (MSRP) can be used to communicate media content to a called subscriber terminal 211A that is part of a wireless access network 210A as shown in FIG. 9. When using MSRP for transport, the media content is broken up into chunks that are communicated to the called subscriber terminal 211A preferably via one or more MSRP relay nodes. The called subscriber terminal 211A then reconstructs the media content from the chunks communicated thereto. The functionality of the MSRP relay node can be realized as part of the processing platform of the query server as described herein or by one or more separate communication nodes. The use of MSRP can mitigate the problems associated with packet loss in the wireless access network 210A. It is contemplated that MSRP can be used to communicate the media content from the calling-subscriber device 3 to the called-subscriber device 5 as part of the “Send Media Packet” command described above and/or as part of the “Send Media” command described above. MSRP can also be used to communicate the media content from the query server 9 to the called-subscriber device 5 as part of the “Send Media Packet” described above and/or as part of the “Send Media” command described above.

Note that query server (or other intermediate node) as described herein can interrogate a content source for information related to the sender-specified media content and forward such information to the receiving party device as part of the sender-initiated alert. For example, such information can be an icon associated with the sender-specified media content, which is displayed on the receiving party device as part of the sender-initiated alert.

The query server (or other intermediate node) can also function to store and forward media content supplied by the sending party for access by the intended receiving party. Such functionality is useful for one-to-many media transfer operations (from one sending party device to many receiving party devices) as well as for enabling download of the stored media content by the sending party and/or the receiving party independent of a sender-initiated alert.

The query server (or other intermediate node) can also function to relay messages (e.g., SIP Invite, MSRP SDP negotiations) for setting up the media transfer operations as described herein. Such messages can be communicated between the sending party device and the receiving party device, between the sending party device and an intermediate node for storing the media content or for accessing the stored media content, and between the intermediate node and the receiving party device for accessing the stored media content in conjunction with a sender-initiated alert (or in a manner independent from the sender-initiated alert). Such messages can also provide the sending party with status of the call setup and media transfer operations as described herein. Such status messages are preferably realized by one or more SIP 183 Progress messages (defined by RFC 3261 of the IETF) and/or one or more PRACK messages (defined by RFC 3262 of the IETF).

It is contemplated that revenue can be generated from many participants of the interactive media-sharing processing described herein, for example from the sender of the media content item (e.g., from a fee charged for communication of the media content item) and from the recipient of the media content item (for example, fees for a save or purchase transaction associated with the media content item or fees for game play invoked from receipt of the media content item).

There have been described and illustrated herein several embodiments of a system and method for communication employing sending-party-specified media content. The user devices of the system employ interactive graphical user interfaces that provide for playback or display of the media content, purchasing and saving the media content if applicable, an interactive history of media content received or sent on the device, and playback and purchasing of such media content. While particular embodiments of the invention have been described, it is not intended that the invention be limited thereto, as it is intended that the invention be as broad in scope as the art will allow and that the specification be read likewise. Thus, while particular communication technologies, system architectures and frameworks, device architectures and command formats have been disclosed, it will be appreciated that other current and future communication technologies, system architectures and frameworks, device architectures and command formats can be used as well to carry out the communication processing of the present invention as described herein. In addition, while particular graphical user interfaces have been disclosed, it will be understood that other graphical user interfaces can be used. For example, other graphical user mechanisms for displaying and selecting parties as well as content items can be used. It is also contemplated that the systems, apparatus and processes described herein can used to announce or alert other real-time communications. It will therefore be appreciated by those skilled in the art that yet other modifications could be made to the provided invention without deviating from its spirit and scope as claimed.

What is claimed is:

1. In a system providing communication between a first user device and at least one second user device, the communication initiated by the first user and including a media content item specified by the first user on a first user device, a software application loaded or loadable onto the at least the second user device, the software application including a graphical user interface that concurrently presents a set of elements to the second user in conjunction with the communication, the set of elements providing at least the following:
i) identification of the first user;
ii) identification of the media content item specified by the first user; and
iii) initiation of a transaction for the media content item specified by the first user.

2. A software application according to claim 1, wherein:
the media content item is played or displayed on the second user device to announce the communication.

3. A software application according to claim 1, wherein:
the graphical user interface is presented on the second user device subsequent to the communication.

4. A software application according to claim 1, wherein:
the communication is of a type selected from the group consisting of a voice call, text message, IM message, PTT communication, media push communication, and game challenge.

5. A software application according to claim 1, wherein:
the transaction is one of a purchase transaction and a save transaction.

6. A software application according to claim 1, wherein:
upon completion of the transaction, the media content item specified by the first user is stored locally on the second user device for subsequent access.

7. A software application according to claim 1, wherein:
upon completion of the transaction, the media content item specified by the first user is stored on a remote system for subsequent access.

8. A software application according to claim 1, wherein:
the set of elements of the graphical user interface include additional elements that invoke a number of predetermined actions associated with the communication.

9. A software application according to claim 8, wherein:
the predetermined actions include a preview action that plays or displays the media content item specified by the first user.

10. A software application according to claim 8, wherein:
the predetermined actions include a reply action that initiates communication back to the first user.

11. A software application according to claim 8, wherein:
the predetermined actions include a forward action that initiates communication of the media content item specified by the first user to another user.

12. A software application according to claim 1, wherein:
the set of elements of the graphical user interface also provide a price for the media content item in the applicable financial or virtual currency.

13. A software application according to claim 1, wherein:
the set of elements of the graphical user interface also provide means for initiating acceptance of the media content item or the communication solicited by the media content item as well as means for initiating termination of the performance of the media content item or the communication solicited by the media content item.

14. A software application according to claim 13, wherein:
the means for initiating acceptance is controlled by input of the second party.

15. A software application according to claim 1, wherein:
the graphical user interface displays information identifying a set of communications that were previously received or sent on the respective user device, and for selecting one of the communications of the set.

16. A software application according to claim 15, wherein:
the respective device includes means for initiating playback or display of the media content item for the selected communication and means for initiation of a transaction pertaining to the media content item of the selected communication.

17. A software application according to claim 16, wherein:
the transaction pertaining to the media content item of the selected communication is one of a purchase transaction and a save transaction.

18. A software application according to claim 16, wherein:
upon completion of the transaction pertaining to the media content item of the selected communication, the media content item of the selected communication is stored locally on the respective device for subsequent access.

19. A software application according to claim 16, wherein:
upon completion of the transaction pertaining to the media content item of the selected communication, the media content item of the selected communication is stored on a remote system for subsequent access.

20. A software application according to claim 15, wherein:
the graphical user interface displays means for initiating other actions with respect the media content item of the selected communication.

21. A software application according to claim 20, wherein:
the other actions include a preview action that plays or displays the media content item of the selected communication.

22. A software application according to claim 20, wherein:
the other actions include a reply action that initiates communication back to the user that originated the selected communication.

23. A software application according to claim 20, wherein:
the other actions include a forward action that initiates communication of the media content item of the selected communication to another user.

24. A software application according to claim 1, wherein:
in the event that the first user has gifted the media content item to the second user, the graphical user interface displays an icon that conveys that the media content item has been gifted to the second user along with a means for the second user to accept the media content item.

25. In a system providing communication between a first user device and at least one second user device, the communication initiated by the first user and including media content item specified by the first user on a first user device, a software application loaded or loadable onto the respective user devices, the software application including a graphical user interface that includes elements that provide the following:
i) information identifying a set of communications that were previously received or sent on the respective user device;
ii) selection of one of the communications of the set;
iii) initiation of playback or display of the media content item for the selected communication; and
iv) initiation of a transaction pertaining to the media content item of the selected communication.

26. A software application according to claim 25, wherein:
the communication is of a type selected from the group consisting of a voice call, text message, IM message, PTT communication, media push communication, and game challenge.

27. A software application according to claim 25, wherein:
the transaction pertaining to the media content item of the selected communication is one of a purchase transaction and a save transaction.

28. A software application according to claim 27, wherein:
upon completion of the transaction pertaining to the media content item of the selected communication, the media content item of the selected communication is stored locally on the respective device for subsequent access.

29. A software application according to claim 27, wherein:
upon completion of the transaction pertaining to the media content item of the selected communication, the media content item of the selected communication is stored on a remote system for subsequent access.

30. A software application according to claim 25, wherein:
the elements of the graphical user interface also provide for initiation of other actions with respect the media content item of the selected communication.

31. A software application according to claim 30, wherein:
the other actions include a preview action that plays or displays the media content item of the selected communication.

32. A software application according to claim 30, wherein:
the other actions include a reply action that initiates communication back to the user that originated the selected communication.

33. A software application according to claim 30, wherein:
the other actions include a forward action that initiates communication of the media content item of the selected communication to another user.

34. A system for real-time communication between a first user operating a first user device and at least one second user operating a respective second user device, wherein the first user device includes means for interacting with the first user to identify the at least one second user and to select a media content item for communication to the respective second user device as part of the real-time communication, the system including:
a server that includes or interfaces to at least one database for storing presence data and permissions data for a plurality of users, wherein presence data and permissions data for a given second user is specified by communication from the respective second user device, and wherein the server includes means for communicating with the first user device to determine serviceability of the given second user for the real-time communication based upon said presence data and said permissions data for the given second user; and
at least one relay node for communicating the media content item selected by the first user to the respective second user device as part of the real-time communication, wherein the media content item is communicated to the respective second user device as a plurality of chunks that are relayed by said at least one relay node.

35. A system according to claim 34, wherein:
functionality of said relay node is realized on a processing platform of said server.

36. A system according to claim 34, wherein:
functionality of said relay node is realized on a communication node separate from said server.

37. A system according to claim 34, wherein:
said multimedia content item is played or displayed on the respective second user device to announce the real-time communication.

38. A system according to claim 37, wherein:
the real-time communication is selected from the group consisting of: voice communication, SMS text messaging, MMS messaging, IM messaging systems, Push-to-Talk communication, and a game challenge.
